(19) United States
(12) Patent Application Publication
(10) Pub. No.: US 2023/0002668 A1
(43) Pub. Date: Jan. 5, 2023

(54) SURFACTANT COMPOSITIONS FOR IMPROVED HYDROCARBON RECOVERY FROM SUBTERRANEAN FORMATIONS

(71) Applicant: Pilot Chemical Corp., West Chester, OH (US)

(72) Inventor: ROBIN SINGH, Oakmont, PA (US)

(21) Appl. No.: 17/765,502

(22) PCT Filed: Oct. 21, 2020
(86) PCT No.: PCT/US20/54124

§ 371 Date: Mar. 31, 2022

Related U.S. Application Data
(60) Provisional application No. 62/924,430, filed on Oct. 22, 2019.
(60) Provisional application No. 62/979,827, filed on Feb. 21, 2020.

(51) Int. Cl. C09K 8/584

(52) U.S. Cl. CPC C09K 8/584

(57) ABSTRACT

The present disclosure relates to surfactants and methods used to increase hydrocarbon recovery from subterranean formations. Novel surfactant compositions are provided. In certain embodiments, the composition is a mixture of a sulfonated primary surfactant, water, and cosurfactants (anionic, zwitterionic/amphoteric or non-ionic surfactant). Methods to use these surfactant compositions to recover oil from formations using processes such as improved oil recovery (IOR) and flow-back processes are also provided.

### REFERENCE TO RELATED APPLICATIONS

The present application claims the priority benefit of U.S. provisional patent application Ser. No. 62/979,827, entitled SURFACTANT COMPOSITIONS FOR IMPROVED HYDROCARBON RECOVERY FROM SUBTERRANEAN FORMATIONS, filed Feb. 21, 2020, and U.S. provisional patent application Ser. No. 62/924,430, entitled SURFACTANT COMPOSITIONS FOR IMPROVED HYDROCARBON RECOVERY FROM SUBTERRANEAN FORMATIONS, filed Oct. 22, 2019, and hereby incorporates each application herein by reference in their respective entireties.

### TECHNICAL FIELD

The present disclosure relates to surfactants and methods used to increase hydrocarbon recovery from subterranean formations. Specifically, it relates to surfactant concentrates used to treat and modify the rock wettability of hydrocarbon-containing formations for improved oil and gas recovery.

### BACKGROUND

Without limiting the scope of the disclosure, this background information is provided herein. Hydrocarbon production from unconventional shale reservoirs has grown immensely in the last decade with the advent of modern hydraulic fracturing and directional drilling technologies. Hydraulic fracturing is a stimulation technique that relies on the injection of fracturing fluids along with solid proppants which can create long, deep propped, primary fractures and/or induce natural microfractures which can increase the conductivity of the formation. However, overall recovery from these reservoirs remains very low and only about 5-10% OOIP (“original oil in place”) is recovered. This can be attributed to the ultra-low permeability of the shale matrix, oil-wet or neutral-wet rock wettability, channeling, and reservoir heterogeneity. With surging global energy demand and consumption globally, it becomes vital to develop solutions to increase hydrocarbon recovery and exploit such complex reservoirs more efficiently.

The wettability of the rock is the tendency of one fluid to preferentially spread over the rock surface in the presence of another fluid. It is a critical petrophysical property that governs the multiphase flow in the pores of a rock and the fluid distribution. Wettability is a function of rock mineralogy, oil composition, water salinity, types of ions, saturation history, and reservoir temperature. There are several methods to characterize the wettability of a porous media including Amott wettability measurements, the U.S. Bureau of Mines (“USBM”) method, and the Nuclear Magnetic Resonance (“NMR”) Longitudinal Relaxation method. However, the most common method is the contact angle (θ) measurement. Depending on the magnitude of the θ, the wettability state of the rock can be classified as either water-wet, neutral-wet, or oil-wet. In porous media, the wetting phase occupies the smaller pores, and the non-wetting phase occupies the larger pores whereas the wetting phase exists as a continuous phase with the thin film adhering to the rock surface. Therefore, in an oil-wet rock, oil recovery is typically poor as the injection fluid has to overcome the negative capillary pressure barrier to invade the rock-matrix and displace oil. In such cases, altering the rock wettability from oil-wet to water-wet is desirable and can increase the oil recovery significantly. The wettability of the rock can be altered using different techniques such as surfactant injection, thermal treatments, injection of low salinity brine or modified brine, and/or alkaline flooding. In the present disclosure, novel surfactant concentrates are disclosed which utilizes the synergy between surfactants and cosurfactants to form a stable, robust, formulation which can alter the wettability of rock surfaces, including shale surfaces, to increase oil recovery significantly.

### SUMMARY

The present disclosure relates to surfactant concentrates and methods used to increase hydrocarbon recovery from subterranean formations. In certain embodiments, the composition is a mixture of a primary surfactants, water, and cosurfactants (anionic, zwitterionic/amphoteric, non-ionic, or cationic). The methods and surfactant concentrates reported herein are useful to recover oil from formations using processes such as enhanced oil recovery (“EOR”), improved oil recovery (“IOR”), hydraulic fracturing process, environmental-remediation, and surfactant-based oil recovery processes in conventional and unconventional reservoirs.

In certain embodiments, the surfactants and cosurfactants described in the concentrates herein, can assist in oil recovery by performing one or more of the following functions:
a. Modifying the wettability of the rocks in the subsurface formation
b. Reduce the interfacial tension between crude oil and water
c. Increase the overall stability of the injection formulation and compatibility with the other additives.

### BRIEF DESCRIPTION OF THE DRAWINGS

FIG. 1 depicts a photograph of a stable and an unstable sample emulsion during the Aqueous Stability Test.

FIGS. 2A and 2B depict photographs showing a shale chip placed on a Teflon® stand submerged in a surfactant formulation in an optical quartz cell and the goniometer digital image used to measure the contact angle of an oil droplet on the shale surfactant respectively.

FIG. 3 depicts a schematic illustrating the high-pressure, high-temperature setup used to saturate tight shale cores.

FIG. 4 depicts a series of photographs showing an oil-wet Eagle Ford shale chip submerged in formulation F2 at 0 days, 2 days, and the goniometer digital image used to measure the contact angel of an oil droplet on the shale chip.

FIG. 5 depicts a graph illustrating the contact angle of the crude oil droplet on the surface of originally oil-wet Wolf Camp shale samples after treatment with different surfactant formulations. Solid bars represent contact angles of samples submerged in formulations with a single surfactant while cross-hatched bars represent contact angles of samples submerged in formulations comprised of a binary mixture of primary surfactant and cosurfactant.

FIG. 6 depicts a graph illustrating the contact angle of the crude oil droplet on the surface of originally oil-wet Eagle Ford shale samples after treatment with different surfactant formulations.

FIG. 7 depicts a graph illustrating the effect of primary surfactant concentration in the surfactant formulation on the contact angle of a crude oil droplet on the surface of originally oil-wet Eagle Ford shale samples.

FIG. 8 depicts a series of photographs showing the decay of bulk emulsions over time.

FIG. 9 depicts a plot showing the normalized emulsion height as a function of time for the bulk emulsions depicted in FIG. 8.

FIGS. 10A and 10B respectively depict a photograph of the initial state of an Indiana limestone core plug 100% saturated with crude oil and a photograph showing the emergence of crude oil droplets on the surface of the Indiana limestone core plugs after submersion in surfactant formulations.

FIG. 11 is the plot of the percentage of original-oil-in-place (OOIP) recovered from strongly-oil-wet (“SOW”) tight limestone cores using various surfactant formulations due to spontaneous imbibition.

FIG. 12 is the plot of the percentage of original-oil-in-place (OOIP) recovered from mixed-wet (“MW”) tight limestone cores using various surfactant formulations due to spontaneous imbibition.

FIG. 13 depicts a photograph showing the crude oil droplets observed on the surface of an oil-wet shale core.

### DETAILED DESCRIPTION

### Definitions

As used herein, the term “interfacial tension” or “IFT” refers to the measurement of the surface energy present at a fluid-fluid interface which arises from the imbalance of forces between molecules at the interface. These interfaces could be between gas/oil, oil/water, or gas/water. The IFT can be measured using different analytical techniques and instruments such as pendant-drop analysis, Du Noüy ring, Wilhelmy plate, and spinning drop tensiometer.

As used herein, the term “surfactant” or “surface-active agents” refers to chemical species that comprise of the hydrophobic tail and hydrophilic head which have the affinity to go at the fluid-fluid interface to lower the interfacial tension. The term “ionic surfactants” refers to the class of surfactants that carries a net charge on the head. These include anionic, cationic and zwitterionic/amphoteric surfactants. Similarly, the term “non-ionic surfactants” refers to the class of surfactants that has no charged groups in its head.

As used herein, the term “subterranean formation” or “subsurface formation” means a hydrocarbon-containing reservoir that is present below the ground which has porosity and permeability to store and flow the hydrocarbon fluids. The lithology of the reservoir could comprise of sedimentary rocks, carbonates such as limestones and dolomites, sandstones, shales, coals, evaporites, igneous, and metamorphic rocks, and combinations thereof. These reservoirs can be fully or partially consolidated or unconsolidated in nature. These formations can be an offshore or onshore reservoir.

As used herein, the term “shale” refers to fine-grained sedimentary rocks which are predominantly comprised of consolidated clay-sized particles. The fine sheet-like clay minerals and the laminated nature of the sediments result in ultra-low permeability which significantly slows down the flow of hydrocarbon within the rock matrix.

As used herein, the term “hydraulic fracturing” refers to the subsurface reservoir stimulation technique which is adopted to increase the conductivity of the low permeability formations such as shale reservoirs or tight sandstone or carbonate reservoirs. Hydraulic fracturing relies on the injection of fracturing fluids to induce fractures which increase the contacted reservoir surface area and the stimulated reservoir volume. Typical fracturing fluids include a wide range of chemical additives that serve different physical and chemical purposes. Common fluids can include acids, biocides, clay stabilizers, breakers, corrosion inhibitors, crosslinkers, friction reducers, gels, viscosifier, polymers, organic or inorganic salts, oxygen scavengers, pH adjusting agents, scale inhibitors, non-emulsifier, aqueous stability enhancer, wettability-altering agents, IFT modifiers and surfactants. Fracturing fluids are often injected with proppants such as natural sand, glass, resin-coated sand, sintered bauxite, ceramic beads, and fused zirconia, which maintain the fracture conductivity after fracture closure by keeping it propped. These fractures along with induced natural fractures act as conductive pathways for hydrocarbon production.

During hydraulic fracturing process, a significant volume of fracturing fluids is injected in the formation. These fluids are often expensive, and it is desired to recover back the fluids after the fracturing is performed so that they could be reused. Moreover, typically leaving behind the fracturing fluid to imbibe in the formation could actually harm the hydrocarbon production. The damage is worsened with time and depth of the imbibition of the fracturing fluids in the formation. Certain chemical additives such as surfactants or microemulsion are often added to recover or produce back the fracturing fluids to the surface. This process is known as “flow back” or “flow-back process”.

As used herein, the term “wettability” refers to the relative adhesion of two fluids to a solid surface. In the present context, it is the affinity of one fluid to adhere to the interstitial surface of the porous media in the presence of the other fluid. These fluids could be formation brine, injection brine, injected aqueous formulations, hydrocarbon (oil and gas) present in the reservoir.

As used herein, the term “contact angle” refers to the quantitative measure of the wettability of the solid surface such as the rock samples by a liquid in the presence of the other liquid. It is measured as the angle at the interface where two fluids and solid surface meet.

As used herein, the term “water-wet” means that in a solid-aqueous-oil system, contact angle as measured from the solid surface through the aqueous phase is less than 75°. Similarly, the term “neutral-wet” refers to contact angle as measured from the solid surface through the aqueous phase is between 750 to 1050 and the term “oil-wet” refers to contact angle as measured from the solid surface through the aqueous phase greater than 105°.

The wettability is a critical parameter that governs the multiphase flow as well as the distribution of fluids through the porous media. As used herein, the term “aging” refers to treating the rock cores or disks to restore its reservoir wettability. It involves saturating the cores with crude oil or submerging the disks in crude oil and placing them at elevated temperature (>80° C. or >176° F.) for a long duration (3 weeks to 1 month).

As used herein, the term “salt” refers to a chemical compound comprising an ionic assembly of cations and anions. It includes inorganic salts such as potassium chloride, ammonium chloride, sodium chloride, calcium chloride, magnesium chloride and organic salts such as sodium acetate, sodium citrate and combination thereof.

As used herein, the term “brine” refers to a mixture of water and soluble salts typically present in the aqueous phase in the hydrocarbon-containing reservoirs. These salts are presents in the form of ions such as but not limited to chloride (Cl⁻), sodium (Na⁺), sulfate (SO4²⁻), magnesium (Mg²⁺), calcium (Ca²⁺), potassium (K⁺), bicarbonate (HCO3⁻), bromide (Br⁻), borate (H2BO3⁻), and strontium (Sr²⁺).

As used herein, the term “total dissolved solids” refers to the total amount of solids dissolved in the water. These solids could comprise water-soluble inorganic materials (minerals, salts, metals, cations, and/or anions) and/or organic materials. It is often reported in parts per million (ppm) or wt %. The typical TDS of seawater is 35,000 ppm or 3.5 wt %.

As used herein, the term “salinity” refers to the total concentrations of salts in the aqueous solution and is expressed in wt. %

As used herein, the term “aqueous stable” means the formulation is both thermally stable as well as colloidally stable at the specified temperature. The formulation is free from any coagulation, phase-separation, or precipitation of any component/phase of the mixture.

As used herein, the term “spontaneous imbibition” or “SI” refers to the process by which one fluid displaces other fluid from a porous media due to the presence of capillary forces. In an SI process, the wetting phase is drawn in the pores of the rock while the non-wetting phase is displaced via a capillary gradient. Therefore, in a water-wet system, significant oil (non-wetting phase) can be recovered from the rock via spontaneous imbibition of water (wetting phase). In contrast, in an oil-wet system, oil (wetting phase) is trapped in the pores of the rock due to negative capillary pressure and water (non-wetting phase) cannot invade the pores to displace the oil. In such a system, changing the wettability of the rock from oil-wet to water-wet can shift the capillary pressure to positive values and spontaneous imbibition can be achieved which mobilizes the trapped oil and increase the overall recovery.

As used herein, the word “Original Oil in Place (“OOIP”)” refers to the estimated total amount of oil present in a given volume of the reservoir. During core saturation or oil displacement experiments, OOIP is typically estimated using the volumetric method or the material balance method as well as the petrophysical data of the cores.

As used herein, the phrase “Huff-n-Puff” or “Huff and Puff” refers to the process of recovering oil from a subsurface formation where a fluid is injected in the well and the well production is temporarily stopped to allow the injection fluid to soak into the reservoir, or interact with the reservoir fluids and rock surfaces, and then the production is resumed again. After producing from the well, this cycle is then continued again. The injection fluid can be, but is not limited to, steam, gases such as carbon dioxide, methane, ethane, produced gas, hydrocarbon gases, surfactant formulations, wettability-altering agents, conformance control agents, stimulation chemicals, and combination thereof.

As used herein, the phrases “enhanced oil recovery” (“EOR”) or “improved oil recovery” (“IOR”) refers to techniques to increase the hydrocarbon recovery from subsurface formations. Typically, IOR techniques can recover more than 20% original-oil-in-place (“OOIP”). It includes, but is not limited to, waterflooding, gasflooding (e.g., injection of hydrocarbon gas, nitrogen and/or carbon dioxide), chemical flooding (e.g., using polymers, surfactants and/or alkalis) and thermal techniques (e.g., steam injection, hot water injection, electrical heating and/or combustion), microbial injections, and combination thereof. IOR can also include stimulation techniques such as hydraulic fracturing and shale acidization which aims at increasing the conductivity of the formation to increase the hydrocarbon recovery. IOR can be applied at any stage of oil and gas production such as primary, secondary, or tertiary oil recovery processes. It could be implemented in any hydrocarbon-bearing formation whose lithology includes sedimentary rocks, carbonates such as limestones and dolomites, sandstones, shales, coals, evaporites, igneous, and metamorphic rocks, and combinations thereof.

In the present disclosure, a novel surfactant concentrate was developed which can be used for treating hydrocarbon-bearing subterranean formations for various applications such as improved oil recovery (“IOR”) or during flow-back processes during hydraulic fracturing. The surfactant concentrates can include:
a. at least one or a mixture of primary surfactants,
b. at least one or a mixture of cosurfactants (or secondary surfactants),

Primary Surfactants

The primary surfactant in the concentrate can be, or can include mixtures of, an anionic sulfonated surfactant represented by Formula I:

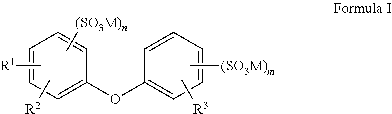

wherein:
R¹—represents a hydrogen, or a linear or branched C₆-C₃₀ alkyl;
R²—represents a hydrogen, or a linear or branched C₆-C₃₀ alkyl;
R³—represents a hydrogen, or a linear or branched C₆-C₃₀ alkyl;
M represents hydrogen, or a cation such as alkali metal, alkaline earth metal, alkanolammonium, aminoalcohol ion, or an ammonium represented by N(R⁴)₄;
wherein R⁴ independently represents a hydrogen, or a linear or branched C₃-C₆ alkyl;
m—represents an integer of 1 or 2; and
n—represents an integer of 0 or 1; and
wherein at least one and no more than two of R¹, R², and R³, represents a linear or branched C₆-C₃₀ alkyl.

In certain embodiments, the primary surfactant is represented by Formula I where:
a) R¹ represents a linear or branched alkyl group with an average carbon chain length of about 6, 10, 12, or 16.
b) R² and R³ represent a hydrogen

In certain embodiments, the primary surfactant can include at least one surfactant from the following family: CALFAX-type, sulfonated surfactants, DOWFAX-type sulfonated surfactants, CALSOFT-type sulfonated surfactants, ARISTONATE-type sulfonated surfactants, and Calimulse-type sulfonated surfactants.

In certain embodiments, the composition of CALFAX-type specialized primary surfactants can include, but is not limited to, C10 (Linear) Sodium Diphenyl Oxide Disulfonate; C16 (Linear) Sodium Diphenyl Oxide Disulfonate; C6 (Linear) Diphenyl Oxide Disulfonic Acid; C12 (Branched) Sodium Diphenyl Oxide Disulfonate; C12 (Branched) Diphenyl Oxide Disulfonic Acid; Sodium Alkyl Diphenyl Oxide Sulfonate; Sodium Decyl Diphenyl Oxide Disulfonate; Benzenesulfonic Acid, Decyl(sulfophenoxy)-, Disodium Salt; Sodium Hexadecyl Diphenyl Oxide Disulfonate; Benzenesulfonic Acid, Hexadecyl(sulfophenoxy)-, Disodium Salt; Hexyl Diphenyl Oxide Disulfonic Acid; Benzene, 1,1′-oxybis-, Sec-hexyl Derivs., Sulfonated; Sodium Dodecyl Diphenyl Oxide Disulfonate; 1,1′-oxybisbenzene Tetrapropylene Derivs., Sulfonated, Sodium Salt; Benzenesulfonic acid, branched dodecyl(sulfophenoxy), disodium salt; Benzenesulfonic acid, decyl(sulfophenoxy), disodium salt; Dodecyl Diphenyl Oxide Disulfonic Acid; Benzene, 1,1′-oxybis-,Tetrapropylene Derivs., Sulfonated; Disodium oxybis(dodecylbenzenesulfonate); Disodium dodecyl(sulfophenoxy)-benzenesulfonate; Sodium dodecyl(phenoxy)-benzenesulfonate; Sodium oxybis(dodecylbenzene)sulfonate; Benzenesulfonic acid, branched dodecyl-, (branched dodecyl phenoxy), sodium salt; Benzenesulfonic acid, phenoxy, branched dodecyl-, sodium salt; Benzenesulfonic acid, oxybis(branched dodecyl-), disodium salt; Disodium oxybis(dodecylbenzenesulfonate); Disodium dodecyl(sulfophenoxy)-benzenesulfonate; Sodium dodecyl(phenoxy)-benzenesulfonate Disodium dodecyl(sulfophenoxy)-benzenesulfonate.

Suitable CALFAX-type surfactants include, but are not limited to, CALFAX 10L-45, CALFAX 16L-35, CALFAX 6LA-70, CALFAX DB-45, CALFAX DBA-40, CALFAX DBA-70. Suitable CALFAX-type surfactants are available from the Pilot Chemical Co. (Cincinnati, Ohio).

In certain embodiments, the primary surfactant in the concentrate can be a DOWFAX-type surfactants. DOWFAX-type surfactants include a pair of sulfonate groups on a diphenyl oxide backbone. The attached hydrophobe may be a linear or branched alkyl group comprised of six to sixteen carbons.

In certain embodiments, DOWFAX-type specialized primary surfactant can include, but are not limited to, 1,1′-oxybisbenzene Tetrapropylene Derivs., Sulfonated, Sodium Salt; Benzene, 1,1′-oxybis-, Sec-hexyl Derivs., Sulfonated; Benzene, 1,1′-oxybis-,Tetrapropylene Derivs., Sulfonated; Benzenesulfonic acid, branched dodecyl(sulfophenoxy), disodium salt; Benzenesulfonic acid, branched dodecyl-, (branched dodecyl phenoxy), sodium salt; Benzenesulfonic acid, decyl(sulfophenoxy), disodium salt; Benzenesulfonic Acid, Decyl(sulfophenoxy)-, Disodium Salt; Benzenesulfonic Acid, Hexadecyl(sulfophenoxy)-, Disodium Salt; Benzenesulfonic acid, oxybis(branched dodecyl-), disodium salt; Benzenesulfonic acid, phenoxy, branched dodecyl-, sodium salt; C10 (Linear) Sodium Diphenyl Oxide Disulfonate; C12 (Branched) Diphenyl Oxide Disulfonic Acid; C12 (Branched) Sodium Diphenyl Oxide Disulfonate; C16 (Linear) Sodium Diphenyl Oxide Disulfonate; C6 (Linear) Diphenyl Oxide Disulfonic Acid; Disodium dodecyl(sulfophenoxy)-benzenesulfonate; Disodium dodecyl(sulfophenoxy)-benzenesulfonate; Disodium oxybis(dodecylbenzenesulfonate); Disodium oxybis(dodecylbenzenesulfonate); Dodecyl Diphenyl Oxide Disulfonic Acid; Hexyl Diphenyl Oxide Disulfonic Acid; Sodium Alkyl Diphenyl Oxide Sulfonate; Sodium Decyl Diphenyl Oxide Disulfonate; Sodium Dodecyl Diphenyl Oxide Disulfonate; Sodium dodecyl(phenoxy)-benzenesulfonate; Sodium dodecyl(phenoxy)-benzenesulfonate Disodium dodecyl(sulfophenoxy)-benzenesulfonate; Sodium Hexadecyl Diphenyl Oxide Disulfonate; Sodium oxybis(dodecylbenzene)sulfonate.

Suitable DOWFAX-type surfactants can include, but are not limited to, DOWFAX 2A1, DOWFAX 3B2, DOWFAX C10L, DOWFAX 8390, DOWFAX C6L, DOWFAX 30599, DOWFAX 2AO. Suitable DOWFAX-type surfactants are available from the Dow Chemical Co. (Midland, Mich.).

The cosurfactants in the surfactant concentrate can be selected from the group comprising at least one or more anionic surfactants, zwitterionic or amphoteric surfactants, non-ionic surfactants, cationic surfactants, or mixtures thereof.

Anionic Cosurfactants

In certain embodiments, the anionic cosurfactants used in the surfactant concentrate can be represented by the general Formula II:

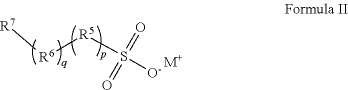

wherein:
R⁵ is a C₅-C₂₀ alkylene chain, a C₆H₄ phenylene group, or O;
R⁶ is alkylene oxide units represented by -(EO)ᵣ—(PO)ₛ—, where EO represents oxyethylene, PO represents oxypropylene, r represents an integer of 0 to 30; s represents an integer of 0 to 30;
R⁷ is a hydrogen or linear or branched C₅-C₂₀ alkyl chain;
p represents an integer of 1 or 2;
q represents an integer of 0 or 1;
M represents a hydrogen, or a cation such as alkali metal, alkaline earth metal, alkanolammonium, aminoalcohol ion, or an ammonium represented by N(R⁴)₄;
wherein R⁴ independently represents a hydrogen, or a linear or branched C3-C6 alkyl;

In certain embodiments, the cosurfactant is an olefin sulfonate-type anionic surfactant represented by Formula II, wherein:
i. R⁵ represents an alkylene chain with average carbon chain length of about 12 or about 14 to 16;
ii. R⁷ represents a hydrogen;
iii. p represents an integer equal to 1; and
iv. q represents an integer equal to 0.

In certain embodiments, the cosurfactant is an alkyl benzene or alkyl aryl sulfonate-type anionic surfactant represented by Formula II, wherein:
i. R⁵ represents a C₆H₄ phenylene group;
ii. R⁷ represents a linear or branched C₅-C₂₀ alkyl chain;
iii. p represents an integer equal to 1; and
iv. q represents an integer equal to 0.

In certain embodiments, cosurfactant in the concentrates can include CALSOFT-type surfactants. CALSOFT-type surfactants are anionic sulfonated surfactants in either salt or acid form.

In certain embodiments, the composition of CALSOFT-type specialized cosurfactant can include, but are not limited to, to, Sodium Alpha Olefin (Cl2) Sulfonate, Sodium Alpha Olefin (Cl4-16) Sulfonate, Sodium Olefin Sulfonate, Sodium Linear Alkyl Benzene Sulfonate, Sodium Linear Alkyl Benzene Sulfonate, Linear Alkyl Benzene Sulfonic Acid, Linear Alkyl Benzene Sulfonic Acid, Sodium Oleic Sulfonate, Triethanolamine Linear Alkyl Benzene Sulfonate. Suitable CALSOFT-type surfactants are available from the Pilot Chemical Co. (Cincinnati, Ohio).

In certain embodiments, cosurfactants in the concentrates described herein can include ARISTONATE-type surfactants. These surfactants are anionic sulfonated surfactants in either salt or acid form.

In certain embodiments, ARISTONATE-type specialized cosurfactants can include, but are not limited to, Sodium Alkyl Aryl Sulfonate, Alkyl Xylene Sulfonates, Calcium Alkyl Aryl Sulfonate, Aristonate C-5000, Aristonate H, Aristonate L, Aristonate M, Aristonate MME-60, Aristonate S-4000, Aristonate S-4600, Aristonate S-5000, Aristonate VH-2. Suitable ARISTONATE-type surfactants are available from the Pilot Chemical Co. (Cincinnati, Ohio).

In certain embodiments, cosurfactants in the concentrates described herein can include CALIULSE-type surfactants. These surfactants are anionic sulfonated surfactants in either salt or acid form.

In certain embodiments, CALIMULSE-type specialized cosurfactants can include, but are not limited to, Isopropylamine Branched Alkyl Benzene Sulfonate, Isopropylamine Linear Alkyl Benzene Sulfonate, Sodium Alpha Olefin Sulfonate, Sodium Cl4-16 alpha olefin sulfonate, Sodium Branched Alkyl Benzene Sulfonate, Branched Dodecyl Benzene Sulfonic Acid, Sodium Linear Alkyl Benzene Sulfonate, Sodium Linear Alkyl Benzene Sulfonate, Sodium Lauryl Sulfate, Sodium Branched Dodecyl Benzene Sulfonate. Suitable CALIMULSE-type surfactants are available from the Pilot Chemical Co. (Cincinnati, Ohio).

In certain embodiments, the cosurfactant is an alkyl sulfate-type anionic surfactant represented by Formula II, wherein:
i. R⁵ represents an O (oxygen);
ii. R⁷ represents a linear or branched C₅-C₂₀ alkyl chain;
iii. p represents an integer equal to 1; and
iv. q represents an integer equal to 0.

In certain embodiments, the cosurfactant is an alkyl ether sulfate-type anionic surfactant represented by Formula II, wherein:
i. R⁵ represents an O (oxygen);
ii. R⁶ is alkylene oxide units represented by -(EO)ᵣ—(PO)ₛ—, where EO represents oxyethylene, PO represents oxypropylene, r represents an integer of 1 to 30; s represents an integer equal to 0;
iii. R⁷ represents a linear or branched C₅-C₂₀ alkyl chain;
iv. p represents an integer equal to 1; and
v. q represents an integer equal to 1.

In certain embodiments of the disclosure, “an anionic cosurfactant” in the concentrate can mean at least one surfactant from the family: CALFOAM-type, alkyl or alkyl ether sulfate surfactants.

In certain embodiments, CALFOAM-type specialized cosurfactants can include, but are not limited to, Ammonium Lauryl Sulfate, Ammonium Lauryl Ether Sulfate (3 Mole EO), Ammonium Decyl Ether Sulfate, Sodium Lauryl Ether Sulfate (1 Mole EO), Sodium Lauryl Ether Sulfate (2 Mole EO), Sodium Laureth Sulfate (2 Mole EO), Sodium Lauryl Ether Sulfate (2 Mole EO), Sodium Lauryl Ether Sulfate (3 Mole EO), Sodium Laureth Sulfate, Sodium Lauryl Ether Sulfate (3 Mole EO), Sodium Decyl Sulfate, Sodium Lauryl Sulfate, TEA Lauryl Sulfate. Suitable CALFOAM-type surfactants are available from the Pilot Chemical Co. (Cincinnati, Ohio).

Zwitterionic and/or Amphoteric Cosurfactants

In certain embodiments, the zwitterionic and/or amphoteric cosurfactants can be represented by the general Formula III or Formula IV:

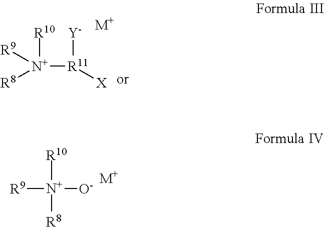

wherein:
R⁸ is a linear or branched, saturated or unsaturated alkyl group with at least 6 carbon atoms or a group represented by R¹²CONH(CH₂)r, where R¹² is a saturated or unsaturated alkyl group with at least 6 carbon atoms; and r represents an integer of 2 to 3;
R⁹ and R¹⁰ is a C₁-C₃ alkyl;
R¹¹ is an alkyl or alkylene group containing 1 to 3 carbon atoms;
X is a hydrogen or hydroxyl group;
Y is a carboxyl or sulfonate group.
M represents a hydrogen, or a cation such as alkali metal, alkaline earth metal, alkanolammonium, aminoalcohol ion, or an ammonium represented by N(R⁴)₄;
wherein R⁴ independently represents a hydrogen, or a linear or branched C3-C6 alkyl;

Formula IV are often referred as amine oxides-type surfactants.

In certain embodiments, the cosurfactant is a hydroxy-sultaine-type zwitterionic and/or amphoteric surfactant represented by Formula III, wherein:
i. R⁸ is a group represented by R¹²CONH(CH₂)r where R¹² is a saturated or unsaturated alkyl group with at least 6 carbon atoms; and r represents an integer of 3; R¹² is preferably lauryl, myristyl, cetyl, stearyl, oleyl, behenyl alkyl groups. R⁸ is preferably derived from natural oils and fats such as sunflower seed oil, coconut oil, tallow, soybean oil, safflower oil, canola oil, corn oil, or mixture thereof
ii. R⁹ and R¹⁰ is a C₁ (methyl) alkyl;
iii. R¹¹ is an alkyl or alkylene group containing 3 carbon atoms;
iv. X is a hydroxyl group;
v. Y is a sulfonate (—SO3⁻) group.

In certain embodiments, the cosurfactant is a betaine-type zwitterionic and/or amphoteric surfactant represented by Formula III, wherein:
i. R⁸ is a group represented by R¹²CONH(CH₂)r where R¹² is a saturated or unsaturated alkyl group with at least 6 carbon atoms; and r represents an integer of 3; R¹² is preferably lauryl, myristyl, cetyl, stearyl, oleyl, behenyl alkyl groups. R⁸ is preferably derived from natural oils and fats such as sunflower seed oil, coconut oil, tallow, soybean oil, safflower oil, canola oil, corn oil, or mixture thereof
ii. R⁹ and R¹⁰ is a C₁ (methyl);
iii. R¹¹ is an alkylene group, CH;
iv. X is a hydrogen;
v. Y is a carboxyl (—COO⁻) group.

In certain embodiments, the cosurfactant is an amine oxides-type zwitterionic and/or amphoteric surfactant represented by Formula IV, wherein:
i. R⁸ is a linear or branched, saturated or unsaturated alkyl group with at least 6 carbon atoms; R⁸ is preferably lauryl, myristyl, cetyl, stearyl, oleyl, behenyl alkyl groups. It is preferably derived from natural oils and fats such as sunflower seed oil, coconut oil, tallow, soybean oil, safflower oil, canola oil, corn oil, or mixture thereof
ii. R⁹ and R¹⁰ is a C₁ (methyl);

In certain embodiments of the disclosure, “an amphoteric cosurfactant” or “a zwitterionic cosurfactant” in the concentrate can mean at least one surfactant from the family: MACAT-type amphoteric/zwitterionic surfactants and CALTAINE-type amphoteric/zwitterionic surfactants.

In certain embodiments, MACAT-type specialized cosurfactants can include, but are not limited to, Laureth Carboxylic Acid, Lauryl Dimethylamine Oxide, Decyl Dimethylamine Oxide, Alkyl Dimethylamine Oxide, Behenamidopropyl Dimethylamine, Cocamidopropyl hydroxysultaine, Cetyl Betaine, Dioctyl Sodium Sulfosuccinate, Lauryl Betaine, Lauryl Cetyl Betaine, Capryl/Capramidopropyldimethyl Betaine, Lauryl Hydroxysultaine, Myristyl/Cetyl Dimethylamine Oxide, Myristyl/Cetyl Dimethylamine Oxide, Tallow Dihydroxyethyl Betaine, Cocamidopropylamine Oxide, Cocamidopropyl Betaine, Lauramidopropylamine Oxide.

In certain embodiments, CALTAINE-type specialized cosurfactants can include, but are not limited to, Cocamidopropyl Betaine, Lauramidopropyl Betaine, Dodecanamidopropyl Betaine, Lauroylamide propylbetaine.

Suitable MACAT-type surfactants and CALTAINE-type surfactants are available from the Pilot Chemical Co. (Cincinnati, Ohio).

Non-Ionic Cosurfactants

In certain embodiments, suitable non-ionic cosurfactants useful for inclusion in the concentrate can be represented by the general Formula V:

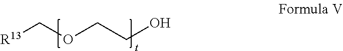

wherein:
R¹³ is a linear or branched C₅-C₂₀ alkyl;
t represents an integer from 1 to 20.

In certain embodiments of the disclosure, “a non-ionic cosurfactant” in the concentrate can mean at least one surfactant from the family: MASODOL-type alcohol ethoxylate non-ionic surfactants.

In certain embodiments, MASODOL-type specialized cosurfactants can include, but are not limited to, C11 alcohol ethoxylate (avg. moles of EO=3), C11 alcohol ethoxylate (avg. moles of EO=5), C11 alcohol ethoxylate (avg. moles of EO=7), C12-15 alcohol ethoxylate (avg. moles of EO=7), C12-15 alcohol ethoxylate (avg. moles of EO=9), C9-11 Alcohol Ethoxylate, C9-11 alcohol ethoxylate (avg. moles of EO=2.5), C9-11 alcohol ethoxylate (avg. moles of EO=6), C9-11 alcohol ethoxylate (avg. moles of EO=8). Suitable MASODOL-type surfactants are available from the Pilot Chemical Co. (Cincinnati, Ohio).

Cationic Cosurfactants

In certain embodiments, the cationic cosurfactants used in the concentrate can be represented by the general Formula VI:

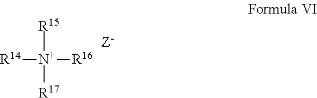

wherein:
R¹⁷ and R¹⁴ is a short chain linear or branched C₁-C₃ alkyl;
R¹⁵ and R¹⁶ are independently selected from linear or branched C₁-C₂₄ alkyl groups or an aromatic, benzyl, alkylamido, aryl or alkylaryl group containing up to about 24 carbon atoms.
Z is a salt-forming anion such halide anions (fluoride, chloride, bromide, and iodide), acetate, and citrate.

In certain embodiments, the cosurfactant can be a cationic surfactant represented by Formula VI, wherein:
i. R¹⁷ and R¹⁴ is a methyl group (—CH₃);
ii. R¹⁵ is a benzyl group (C₆H₅CH₂—);
iii. R¹⁶ is a linear or branched C₁-C₂₄ alkyl; preferably, majority linear C₁₂ chain length with less C₁₄ (67% C₁₂, 25% C₁₄, 7% C₁₆, 1% C18) or majority linear C₁₄ chain length with less C₁₂ (50% C₁₄, 40% C₁₂, 10% C₁₆).

Other tradenames of specialized cosurfactants can include, but are not limited to, Aromax®, Petronate®, Genagen®, Genaminox™, Genapol®, Emersal™, Standapol®, Sulfotex™, Ammonyx®, Amphosol®, Bio-Soft®, Bio-Terge®, Maprofix™, Nacconol®, Ninnate™, Polystep®, Steol®, Stepnol™, Mirataine®, Rhodacal®, Rhodapex®, Rhodapon®, Sipex™, Siponate™, Witcolate™, Witconate™.

In certain embodiments, the aforementioned surfactant concentrate is useful hydrocarbon recovery by different processes such as enhanced oil recovery (“EOR”), improved oil recovery (“IR”), flow-back process during hydraulic fracturing, environmental-remediation and surfactant-based oil recovery processes in conventional and unconventional reservoirs.

In certain embodiments, the surfactant concentrates described herein can comprise about 5 wt. % to about 95 wt. % water, about 5 wt. % to about 95 wt. % of the primary surfactants, and about 0.01 wt. % to about 95 wt. % of the cosurfactants.

As used herein, the term “primary surfactant” or “cosurfactant” or “secondary surfactant” does not imply that the concentration of one is greater, same or less than the other.

As used herein, the term “injection formulation” refers to the fluid system obtained by diluting the aforementioned surfactant concentrate with or without additional additives that can be injected into the injection well in a hydrocarbon-bearing formation.

In certain embodiments, the injection formulation could be made diluting the concentrate with a water source such that the concentration of primary surfactant and cosurfactants is within the range of about 0.01 wt. % to about 30 wt. %.

In certain embodiments, the water source can be freshwater, produced water, recycled water, tap water, well water, deionized water, distilled water, produced water, municipal water, wastewater, treated or partially treated wastewater, brackish water, or seawater, or a combination of two or more.

In certain embodiments, the injection formulation can include about 0.01 wt. % to about 30 wt. % total dissolved solids (“TDS”). The solids can include inorganic salts such as potassium chloride, ammonium chloride, sodium chloride, calcium chloride, magnesium chloride and organic salts such as sodium acetate, sodium citrate and combination thereof.

In certain embodiments, the injection formulation can include about 0 wt. % to about 30 wt. % of one or more additives selected from the group consisting of acids, biocides, clay stabilizers, breakers, corrosion inhibitors, crosslinkers, friction reducers, polymers, oxygen scavengers, pH adjusting agents, scale inhibitors, non-emulsifier, and mixture thereof.

Additives

Acids

In certain embodiments, suitable acid additives can be selected from the group including phosphoric acid, sulfuric acid, sulfamic acid, malic acid, citric acid, tartaric acid, maleic acid, methylsulfamic acid, chloroacetic acid, hydrochloric acid, hydrofluoric acid, hydrobromic acid, hydroiodic acid, formic acid, acetic acid, polylactic acid, polyglycolic acid, lactic acid, glycolic acid, and combinations thereof.

Biocides

In certain embodiments, suitable biocide additives can be selected from the group of non-oxidizing or oxidizing biocides. The non-oxidizing biocides includes, but is not limited to, aldehydes such as glutaraldehyde, quaternary ammonium salts such as didecyldimethyl ammonium chloride, alkyl dimethylbenzyl ammonium chloride, halogenated compounds such as 2-2-dibromo-3-nitrilopropionamide (“DBNPA”), sulfur compounds such as isothiazolone, carbamates, and metronidazole), tris(hydroxymethyl)nitromethane (“THNM”) and quaternary phosphonium salts such as tetrakis(hydroxymethyl)phosphonium sulfate (“THPS”), and combinations thereof. The oxidizing biocides can include, but are not limited to, chlorine, alkali and alkaline earth hypochlorite salts, sodium hypobromite, activated sodium bromide, or brominated hydantoins, chlorine dioxide, ozone, inorganic persulfates such as ammonium persulfate, or peroxides, such as hydrogen peroxide, organic peroxides, peroxy compounds, such as peracetic acid, and combinations thereof.

Clay Stabilizers

In certain embodiments, suitable clay stabilizer additives can be selected from one or more of choline bicarbonate, choline chloride, potassium chloride, ammonium chloride, various metal halides, aliphatic hydroxyl acids, tetramethyl ammonium chloride (TMAC), dimethyl diallyl ammonium salt, N-Alkyl pyridinium halides, N,N,N-Trialkylphenylammonium halides, N,N-dialkylmorpholinium halides, polyoxyalkylene amines, amine salts of maleic imide, quaternized polymers, and combination thereof.

Breakers

In certain embodiments, breaker additives can be selected from the group of oxidative breakers such as potassium persulfate, ammonium persulfate (APS), alkali metal hypochlorites and inorganic and organic peroxides, perphosphate esters or amides, redox gel breakers such as cooper ions and amines, enzyme-gel breakers, encapsulated gel breakers, and combinations thereof.

Corrosion Inhibitors

In certain embodiments, corrosion inhibitor additives can be selected from phosphonic acid, hydrazine hydrochloride, 1,2-dithiol-3-thiones, isopropanol, methanol, formic acid, acetaldehyde, aldehyde, quaternary ammonium salts, N,N-dimethylformamide, ammonium bisulfate, iron complexing agents such as glucono-delta-lactone, citric acid, ethylene diamine tetraacetic acid, nitrilo triacetic acid, hydroxyethylethylene, diaminetriacetic acid, hydroxyethyliminodiacetic acid, derivatives thereof, and combinations thereof.

Crosslinkers

In certain embodiments, crosslinker additives can be selected from borate crosslinkers, aldehydes, e.g., formaldehyde, acetaldehyde, glyoxal, and glutaraldehyde, dimethylurea, polyacrolein, diisocyanate, divinylsulfonate, aluminum citrate, chromium sulfate, ferrochrome lignosulfonate, manganese nitrate, potassium bichromate, sodium bichromate, ferric acetylacetonate, ammonium ferric oxalate, derivatives thereof, and combinations thereof.

Friction Reducers

In certain embodiments, friction reducer additives can be selected from polyacrylamide (“PAM”) polymers, copolymers of sodium acrylamido-2-methylpropane sulfonate (“sodium AMPS”) and acrylic acids, copolymer of acrylamide and sodium acrylate monomers, hydrolyzed polyacrylamide (“HPAM”), guar polymer in emulsion or granular forms, and combinations thereof.

Polymers

In certain embodiments, suitable polymer additives can be selected from star macromolecules having a core and a plurality of polymeric arms, copolymers of acrylamide, methacrylamide, acrylic acid (AA), or methacrylic acid, or those from 2-acrylamido-2-methyl-1-propane sulfonic acid (“AMPS”) derivatives and N-vinylpyridine, copolymer of acrylamide and sodium acrylate monomers, hydrolyzed polyacrylamide (HPAM), guar-based gelling agents such as hydroxypropyl guar, glycols such as ethylene glycol, anionic galactomannans, modified hydroxyethyl cellulose, gellan gum, wellan gum, xanthan gum, scleroglucan, and combinations thereof.

Oxygen Scavengers

In certain embodiments, oxygen scavenger additives can be selected from ammonium bisulfate, hydrazine, ascorbic acid, hydroquinone, bisulfite salts, sodium hydrosulfite, and combinations thereof.

pH-Adjusting Agents

In certain embodiments, pH-adjusting agents can be selected from hydrochloric acid, hydrofluoric acid, citric acid, additional alkanolamine compounds, sulfuric acid, ammonium hydroxide, sodium hydroxide, magnesium oxide, sodium sesquicarbonate, sodium carbonate, amines such as hydroxyalkyl amines, anilines, carboxylates such as acetates and oxalates, tetramethylammonium hydroxide, derivatives thereof, and combinations thereof.

Scale Inhibitors

In certain embodiments, scale inhibitor additives can be selected from polymeric scale inhibitors such as phosphorus end-capped polymers, polyaspartate polymers, polyvinyl sulfonates polymers or copolymers, polyacrylic acid based polymers, sodium salt of acrylamido-methyl propane sulfonate/acrylic acid copolymer (AMPS/AA), phosphinated maleic copolymer (PHOS/MA) or sodium salt of polymaleic acid/acrylic acid/acrylamido-methyl propane sulfonate terpolymers (PMA/AMPS), phosphate ester, phosphoric acid, phosphonate, phosphonic acid, a polyacrylamide, and mixtures thereof.

Non-Emulsifiers

In certain embodiments, non-emulsifier additives can be selected from sorbitan alkanoate, diepoxide, polyamine, 2-ethyl-1-hexanol, nonyl/butyl base catalyzed resin, nonyl/butyl acide catalyzed resin, alkylphenol ethers, alkyl phosphates, silicone glycol copolymers, phosphate esters, glucosides such as cetearyl glucoside, alkyl polyglucosides, and alkoxylated triglycerides, primary alcohol alkoxylates, secondary alcohol alkoxylates, fatty alcohol alkoxylates, fatty acids ethoxylate, fatty acid ester soaps, and mixtures thereof.

In certain embodiments of the disclosure, the method, termed herein as improved oil recovery (“IOR”), for recovering hydrocarbon from a subterranean formation which has at least one injection well and/or one production well penetrated in the hydrocarbon-containing zone comprises injecting a mixture of primary surfactants and cosurfactants through the well.

In certain embodiments, an improved oil recovery (“IOR”) composition obtained by diluting the surfactant concentrate developed in the present disclosure for treating subterranean formation to increase the hydrocarbon recovery, comprises:
a. about 0.01 wt. % to about 30 wt. % of at least one or a mixture of primary surfactants;
b. about 0.01 wt. % to about 30 wt. % of at least one or a mixture of cosurfactants; and
c. about 0 wt. % to about 40 wt % of one or more additives.

In certain embodiments, the improved oil recovery (“IOR”) composition can yield a contact angle of crude oil on a rock surface, as measured through the aqueous phase, of less than 60°. Thus, it has the capability to alter the wettability of the initial oil-wet or neutral-wet rock to strongly water-wet state which help recover additional oil from the reservoir.

The improved oil recovery (IOR) composition can result in greater than 10%, greater than 20%, greater than 30%, and even greater than 50% OOIP (original-oil-in-place) oil recovery during spontaneous imbibition tests indicating the potential of assisting in hydrocarbon recovery in field applications. Note that such spontaneous imbibition tests as a good screening tool to optimize the surfactant formulations.

The improved oil recovery (IOR) composition can be injected through a wellbore to increase the oil recovery. It remains aqueous stable before injection in the wellbore, within the wellbore as well as when it interacts and mixes with the formation fluids at reservoir temperature.

A flow-back process composition obtained by diluting the previously described concentrate of for treating subterranean formation to increase the hydrocarbon recovery, can include:
a. about 0.01 wt. % to about 30 wt. % of at least one or a mixture of primary surfactants;
b. about 0.01 wt. % to about 30 wt. % of at least one or a mixture of cosurfactants; and
c. about 0 wt. % to 40 about wt. % of one or more additives.

The flow-back process composition can yield a contact angle of crude oil on a rock surface, as measured through the aqueous phase, of greater than 750 indicating the formulation is able to alter or keep the wettability of the rock surface to either neutral-wet or oil-wet conditions. The flow-back process composition can prevent the trapping of hydraulic fracturing fluids due to water imbibition in shale rocks and increase the amount of flow-back fluids which help increase the hydrocarbon production.

In certain embodiments, the flow-back process composition can be injected with other hydraulic fracturing fluids during the fracturing stage through the injection well.

The flow-back process composition can remain aqueous stable before injection in the wellbore, remain stable within the wellbore, and remain stable when it interacts and mixes with the formation fluids at reservoir temperatures.

In certain embodiments of the methods described herein, the injection well and the production well can be the same, and the same well can be used for both injecting and producing fluids.

In certain embodiments of the methods described herein, injection formulations including a mixture of primary surfactants and cosurfactants can be injected in the reservoir using the injection well to sweep the reservoir and the fluids such as hydrocarbon, formation water, and injection fluids are produced from a production well which is hydraulically connected to the injection well.

In certain embodiments of the methods described herein, the low permeability of the reservoirs can make it challenging for the surfactant formulation to be injected deep into the formation to sweep the reservoir and produce from the production well. Some examples of such reservoirs include, but are not limited to, unconventional shale reservoirs, tight carbonate and sandstone reservoir with permeability less than 10 mD. In such cases, first, the production from the reservoir can be halted. It is followed by the injection of the surfactant formulations from the injection well for a fixed period which varies from a few hours to weeks. Optionally, both injection/productions well could be shut-in which will allow the injected formulation to soak into the reservoir and alter the wettability of the contacted reservoir and/or reduce the interfacial tension between the oil/water interface. This process is often referred as “soaking” in the industry and often used during huff-n-puff process of gas injection in tight formation. After a soaking period, the production from the reservoir can be resumed from the same injection well.

As can be appreciated, the method of using the injection formulation reported in the present disclosure is not limited to just injecting aqueous surfactant formulation only into the reservoir and can be implemented with other oil recovery processes such as Huff-N-Puff process in unconventional shale reservoir and tight carbonate and sandstone reservoirs, chemical enhanced oil recovery (“EOR”) processes such as surfactant EOR, alkaline-surfactant-polymer (“ASP”) EOR, foam EOR, steam foam EOR, soil remediation, etc.

In certain embodiments, the flow-back process composition reported in this disclosure can be used during the hydraulic fracturing process as a part of the completion fluid or hydraulic fracturing fluid package.

In certain embodiments of the methods described herein, where the surfactants and cosurfactants present in the injection formulation can assist in oil recovery by performing at least one or more of the following functions:
a. Modifying the wettability of the rocks in the subsurface formation
b. Reduce the interfacial tension between crude oil and water
c. Increase the overall stability of the injection formulation and compatibility with the other additives.

In certain embodiments of the methods described herein, the injection formulation can remain aqueous stable before injection in the wellbore, within the wellbore as well as when it interacts and mixes with the formation fluids at reservoir temperature.

In certain embodiments of the methods described herein, the well into which the injected formulation is injected can be an oil-wet or neutral-wet reservoir.

In certain embodiments of the methods described herein, the reservoir temperature of the subterranean formation can be greater than 68° F. (20° C.).

### Methods of Use

### Methods and Materials

Core samples of different lithologies were used. These included, but were not limited to, shale cores from Eagle Ford, Wolf Camp, Appalachian formations, carbonate cores such as Indiana Limestone, and sandstone cores such as those from Boise and Berea. Potassium chloride was used as received from Fisher Chemical (Hampton, N.H.). Deionized water with a resistivity greater than 18.2 MΩ-cm was used to prepare the surfactant formulations. The crude oils were obtained from two different oil reservoirs in Texas and Pennsylvania and had a density of 0.819 g/cm³ at 25° C.

Aqueous Stability Tests

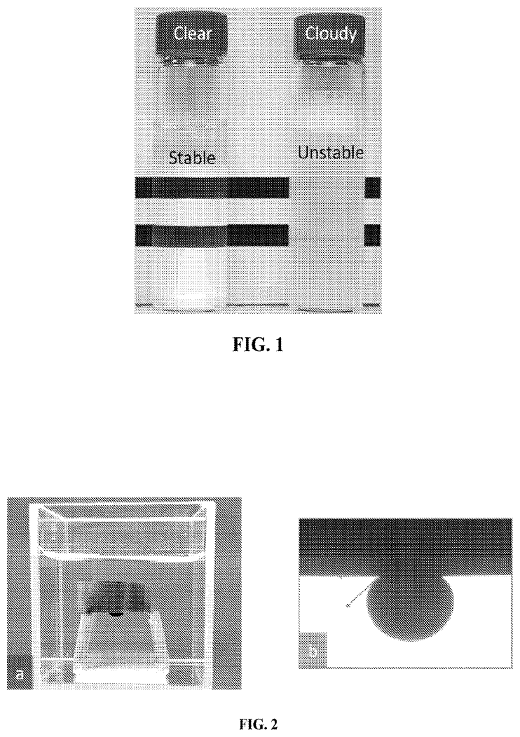

The long-term aqueous stability of surfactant formulations at different salinities was monitored at reservoir temperatures for several months. 15 ml of formulations were taken in glass vials with PTFE-lined caps and placed in ovens operating at reservoir temperature. The aqueous stability of the samples was monitored visually for two months. FIG. 1 shows a photograph of a stable and an unstable formulation. A sample which remains optically clear (as shown in FIG. 1) and shows no sign of phase separation or precipitation is considered stable and has passed the Aqueous Stability Test. In contrast, unstable samples failing the Aqueous Stability Test had a hazy appearance (as shown in FIG. 1), clear phase separation, and/or precipitation.

Contact Angle Experiments

Contact angle experiments were performed to quantify the changes in the wettability of rock before and after the treatment with a surfactant formulation using a goniometer (Dataphysics OCA-15EC). The cores used in the Contact Angle Experiments included sandstone, carbonate, and shale. Cores (diameter: 1 inch) were prepared by cutting the cores into 1-inch long disks using a tile saw with a diamond blade cutter. These disks were polished by a slant cabber polishing machine equipped with a diamond abrasive plate (400 grit) to make the surface smooth. The polished disks were immersed in formation brine and were incubated at reservoir temperature for at least 24 hours to attain ionic equilibrium. These disks were then submerged in crude oil at 85° C. for one month for “aging” which renders them oil-wet in nature

The oil-wet disks were placed in different surfactant formulations at reservoir temperature (85° C.) for 2 days. These disks were then washed with formation brine to remove any bulk oil sticking to the surface and were placed in an optical quartz cell filled with injection brine as depicted in FIG. 2A. A crude oil droplet was introduced at the bottom of the disk using a U-shaped hypodermic needle and the automated dosing system and the contact angles were measured using the goniometer as depicted in FIG. 2B. Several oil droplets were placed on random locations on the disks and the average contact angle values with standard deviations were calculated.

Bulk Emulsion Stability Test

During the injection of surface-active chemicals, such as surfactants, during IOR processes, the injection fluids can undergo vigorous mixing with formation fluids which can lead to the formation of an in-situ emulsion in the porous media. The formation of such emulsions is often undesirable owing to the high viscosity of the emulsion which can lead to injectivity issues. The Bulk Emulsion Stability Test quantifies and compares the stability of emulsions. In the Bulk Emulsion Stability Test, crude oil and the surfactant formulations are prepared in a 30:70 ratio, by volume, in glass vials. The mixtures were agitated at high shear using a rotor-stator homogenizer (Scilogex D160) operating at 8,000 rpm for 45 seconds. The stability of the emulsion was quantified in terms of the normalized emulsion height (NEH) as a function of time. Digital images of the vials were taken, and image processing software ImageJ was used to calculate the NEH.

Interfacial Tension (IFT)

The crude oil-aqueous phase interfacial tension (IFT) was measured via a pendant droplet method using the Dataphysics OCA-15EC goniometer. Different surfactant formulations were taken in an optical quartz cell and a droplet of crude oil was suspended for sufficient time to allow it to equilibrate with the aqueous phase using a U-shaped hypodermic needle. The IFT was measured using the in-built software by fitting the drop profile with the Young-Laplace equation.

Core Characterization and Saturation

Tight Carbonate Cores

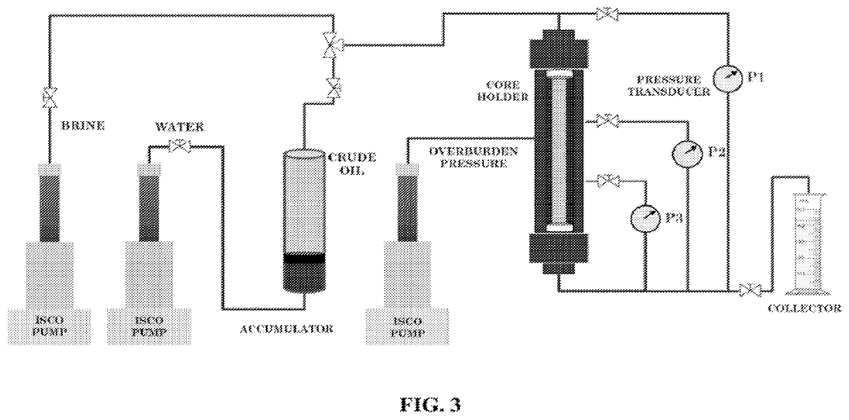

Tight carbonate cores were prepared to mimic reservoir conditions in order to evaluate the performance of different surfactant formulations for increased oil recovery. Oil-free, cylindrical cores, 1″ or 1.5″ in diameter and 1 ft long, were prepared by first drying the cores at 85° C. for 48 hours in an oven. The cores were then covered with fluorinated ethylene propylene (“FEP”) heat-shrink wrap tubing and placed vertically in a Hassler-type core holder under a confining overburden pressure of 1500 psi. The schematic of the high-pressure, high-temperature setup is depicted in FIG. 3.

Petrophysical properties of the cores such as brine porosity were measured by performing a vacuum saturation of formation brine. The permeability of the cores was then measured by injecting formation brine at different flow rates and measuring the differential pressure drop across the cores. The crude oil was then injected from the top of the core at constant high-pressure of 1000 psi in the brine-saturated core until residual water saturation was achieved. To minimize any capillary end-effects, more than 4 PV of oil was injected. In some cases, a direct vacuum saturation of crude oil was performed to achieve 100% oil saturation. The oil-saturated cores were then taken out of the core holder and were submerged in crude oil bottle and placed in the oven at 85° C. for 1 month for “aging” which renders the cores oil-wet in nature.

Ultra-Tight Shale Cores

Ultra-tight shale cores having ultra-low permeability and porosity could not be prepared with the ‘Tight Carbonate Cores’ method. To prepare ultra-tight shales cores, Eagle Ford and Wolf Camp cores, having a 1″ diameter and measuring 6-inches long, were dried at 85° C. for 15 days and then the dry weights were measured. The cores were then placed in a high-pressure piston accumulator filled with crude oil. The system was pressurized at 2750 psi by running an ISCO syringe pump at constant pressure. The whole setup was heated at 85° C. in an oven and the pressure was maintained for 45 days. The crude oil slowly imbibed into the cores. The amount of oil imbibed was calculated gravimetrically.

Spontaneous Imbibition Test

The Spontaneous Imbibition Test was performed to quantify the efficacy of different surfactant formulations in altering the wettability of the cores, inducing surfactant solution imbibition and improved oil recovery. A custom imbibition glass cell was fabricated by Ace Glass, Inc. (Vineland, N.J.) capable of withstanding high-temperature and high-pressure. The custom imbibition glass cell comprised a cylindrical chamber and a thin graduated tube attached to the top to collect oil. Such a cell is often referred to in the literature as an “Amott Cell”. The diameter of the graduated tube was designed based on the amount of expected oil recovery to ensure measurement accuracy. Each oil-saturated core was loaded in the cell and it was filled with the surfactant formulations until a fixed liquid level was reached. Both ends of the cell were securely closed using threaded-Teflon screws and O-rings to prevent evaporation and the cell placed in the oven at reservoir temperature. The oil recovered from the core accumulated in the graduated tube and was monitored with time.

### Examples

The following examples are reported to illustrate the present disclosure.

The cores from the Eagle Ford shale formation were cut into small disks (diameter: 1 inch and length: about 1 inch). The disks smoothed using a polishing machine and then were equilibrated with brine (5 wt. % potassium chloride or KCl) for 24 hours. The potassium chloride prevents swelling of clays which can affect the results. The contact angle of the Texas crude oil was measured on one of the disks to quantify the wettability of the rock before any aging process. The unmodified contact angle was found to be 98.3°+7.0° indicating the neutral-wet nature of the rock. The remaining disks were then submerged in the Texas crude oil at 85° C. for one month for aging to mimic the wettability state in the subsurface reservoir. During this aging process, the indigenous or naturally occurring crude oil components such as naphthenic and carboxylic acids tend to adsorb on the surface of the rock to render it oil-wet in nature. This wettability alteration toward oil-wet nature is strongly governed by the oil composition, brine salinity, temperature and duration of aging. To confirm that the oil used in this present disclosure can alter the wettability of the shale disks to oil-wet, contact angle experiments were performed to quantify the wettability state of the disks post-aging.

To measure the contact angle, an aqueous phase comprised of 5 wt. % KCl with no added surfactants was used (Formulation F1). The aged shale disk was submerged in the formulation F1 for 48 hours at 85° C. in the oven. The disk was then placed on a Teflon stand in the quartz optical cell submerged in the brine (5 wt. % KCl). When the crude oil droplet was introduced at the bottom of the disk, it resulted in the complete spreading of the oil droplet and a contact angle of 1800 was observed confirming the strong oil-wetness of the shale disks. The wettability state obtained via formulation F1 which contains no surfactants was used as a base case or reference wettability to compare the results with other formulations in Table 1 and Table 2.

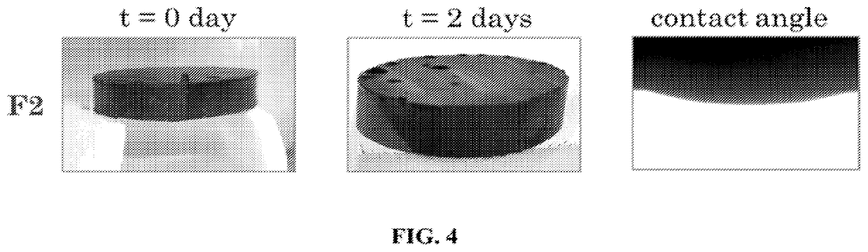

To determine the effects of the surfactant formulations described herein, other oil-wet Eagle Ford shale disks were submerged in the various surfactant formulations at a reservoir temperature of 85° C. for 48 hours. Such a process mimics the treatment of shale formations in the subsurface environment. After the treatment, the disks were taken out of the formulations and washed gently with brine (5 wt. % KCl) to remove any bulk oil sticking to the surface. These disks were then placed in an optical quartz cell and were submerged in brine (with no surfactants) and the contact angle test was performed. Photographs of the contact angle measurement process are depicted in FIG. 4. Herein, these different surfactant formulations are labeled as “F” followed by a numeric number. These formulations comprise of one surfactant or a mixture of multiple surfactants in a known ratio. The salinity of the formulation #F1 to F38 was kept constant and was formulated in 5 wt. % KCl solution.

The Tables labels the surfactants as “A”, “Z”, or “N” based on surfactant-type (A for anionic, Z for zwitterionic/amphoteric, and N for non-ionic). The final wettability state of the rock samples was determined by the magnitude of the contact angle (θ). The final wettability was categorized as either Water Wet (“WW”) for a θ<75°, Neutral Wet (“NW”) for 75°<θ<105°, or Oil Wet “OW” for a θ>105°. As can be appreciated, different oil recovery processes prefer different wettability states. For improved oil recovery application, a preferential water-wet wettability is preferred. In Tables 1 to 4, surfactant formulations which yields a contact angle, θ <600 is considered to have pass the contact angle test for IOR application and a contact angle, θ >60° is considered to have failed the test. In contrast, for flow-back applications, the final wettability of rock after surfactant formulation treatment is preferred to be less water-wet. Herein, in Table 1 to 4, the surfactant formulations which yields a contact angle, θ>750 is considered to have passed the contact angle test while θ<750 is considered to have failed the test for flow-back applications.

Table 1 summarizes the results of the contact angle test on for the different surfactant formulations (F2 to F14) comprising of single surfactant at a constant salinity (5 wt. % KCl) and the corresponding contact angle of the oil droplet post-treatment with these formulations. The total surfactant concentration was 0.5 wt % in all formulations.

TABLE 1
Eagle Ford Shale Samples

| | | | | Average | | | | |
|---|---|---|---|---|---|---|---|---|
| | | Trade | | Contact | Std. | Final | IOR | Flow-Back |
| # | Chemistry | Name | Type | Angle | Dev | Wettability | Application | Application |
| F1 | Formation Brine | — | — | 180.0 | 0.0 | OW | Fail | Pass |
| F2 | C10 (Linear) | Calfax | A | 160.9 | 2.5 | OW | Fail | Pass |
| | Sodium | 10L-45 | | | | | | |
| | Diphenyl Oxide | | | | | | | |
| | Disulfonate | | | | | | | |
| F3 | C16 (Linear) | Calfax | A | 153.4 | 9.9 | OW | Fail | Pass |
| | Sodium | 16L-35 | | | | | | |
| | Diphenyl Oxide | | | | | | | |
| | Disulfonate | | | | | | | |
| F4 | C12 (Branched) | Calfax | A | 154.4 | 19.5 | OW | Fail | Pass |
| | Sodium | DB-45 | | | | | | |
| | Diphenyl Oxide | | | | | | | |
| | Disulfonate | | | | | | | |
| F5 | C6 (Linear) | Calfax | A | 154.0 | 23.0 | OW | Fail | Pass |
| | Diphenyl Oxide | 6LA-70 | | | | | | |
| | Disulfonic Acid | | | | | | | |
| F6 | C12 (Branched) | Calfax | A | 155.4 | 12.0 | OW | Fail | Pass |
| | Diphenyl Oxide | DBA-70 | | | | | | |
| | Disulfonic Acid | | | | | | | |
| F7 | Sodium Alpha | Cal soft | A | 74.7 | 12.6 | WW | Fail | Fail |
| | Olefin (C12) | AOS | | | | | | |
| | Sulfonate | 1245 | | | | | | |
| F8 | Cocamidopropyl | Macat | Z | 88.8 | 5.7 | NW | Fail | Pass |
| | hydroxysultaine | CAP HS | | | | | | |
| F9 | Lauramidopropyl | Caltaine | Z | 78.3 | 6.7 | NW | Fail | Pass |
| | Betaine | L-35 | | | | | | |
| F10 | Lauryl | Macat | Z | 83.0 | 8.1 | NW | Fail | Pass |
| | Hydroxysultaine | LHS | | | | | | |
| F11 | Decyl | Macat | Z | 147.6 | 27.2 | OW | Fail | Pass |
| | dimethylamine | AO-10 | | | | | | |
| | oxide | | | | | | | |
| F12 | Ammonium | Calfoam | A | 51.6 | 14.6 | WW | Pass | Fail |
| | Lauryl Ether | EA-603 | | | | | | |
| | Sulfate | | | | | | | |
| | (3 Mole EO) | | | | | | | |
| F13 | Sodium Decyl | Calfoam | A | 60.3 | 12.4 | WW | Fail | Fail |
| | Sulfate | SDS-30 | | | | | | |
| F14 | Cocamidopropyl | Caltaine | Z | 44.5 | 7.4 | WW | Pass | Fail |
| | Betaine | C-35 | | | | | | |

As depicted in Table 1, the disulfonate surfactants (F2, F3, and F4) and disulfonic acids (F5 and F6) alone were not able to alter the wettability of the shale samples and had contact angles greater than 105°.

Other anionic surfactants (F12, F13) and zwitterionic surfactants (F8, F9, F10, F14) were able to alter the wettability of the samples disks from oil-wet (OW) to either neutral wet (NW) or water-wet (WW). For example, formulation, F9 which comprises of 0.5 wt. % of Lauramidopropyl Betaine was able to alter the wettability from the initially strongly oil-wet (base case=180°) to a neutral-wet state with contact angle 78.3°±6.7°.

In the present disclosure, it was found that by incorporating a primary surfactant with an individual or mixtures of anionic, zwitterionic/amphoteric or non-ionic surfactants a strong synergy in wettability alteration capability from oil-wet to strongly water-wet can be achieved. To illustrate this, Table 2 lists the results of such formulations containing a binary mixture of surfactants used to treat the initially oil-wet Eagle Ford shale disks. The primary surfactant in these formulations (F15 to F22) was the same and comprises of 0.1 wt. % C10 (Linear) Sodium Diphenyl Oxide Disulfonate (Trade Name: Calfax 10L-45). The total salinity in these formulations was kept constant and equal to 5 wt. % KCl. The concentration of cosurfactant in these cases was kept constant and equal to 0.4 wt. %. Thus, the ratio of primary surfactant to cosurfactant was constant and equal to 1:4.

TABLE 2
Eagle Ford Shale Samples

| | | | | Average | | | | |
|---|---|---|---|---|---|---|---|---|
| | Cosurfactant | Trade | | Contact | Std. | Final | IOR | Flow-Back |
| # | Chemistry | Name | Type | Angle | Dev | Wettability | Application | Application |
| F15 | Sodium Alpha | Calsoft | A | 171.0 | 4.5 | OW | Fail | Pass |
| | Olefin (C12) | AOS | | | | | | |
| | Sulfonate | 1245 | | | | | | |
| F16 | Cocamidopropyl | Macat | Z | 44.0 | 6.5 | WW | Pass | Fail |
| | hydroxysultaine | CAPHS | | | | | | |
| F17 | Lauramidopropyl | Caltaine | Z | 42.9 | 5.5 | WW | Pass | Fail |
| | Betaine | L-35 | | | | | | |
| F18 | Lauryl | Macat | Z | 55.6 | 10.9 | WW | Pass | Fail |
| | Hydroxysultaine | LHS | | | | | | |
| F19 | Decyl | Macat | Z | 163.3 | 9.4 | OW | Fail | Pass |
| | dimethylamine | AO-10 | | | | | | |
| | oxide | | | | | | | |
| F20 | Ammonium | Calfoam | A | 61.1 | 14.6 | WW | Fail | Fail |
| | Lauryl Ether | EA-603 | | | | | | |
| | Sulfate | | | | | | | |
| | (3 Mole EO) | | | | | | | |
| F21 | Sodium Decyl | Calfoam | A | 163.9 | 10.0 | OW | Fail | Pass |
| | Sulfate | SDS-30 | | | | | | |
| F22 | Cocamidopropyl | Caltaine | Z | 47.9 | 6.6 | WW | Pass | Fail |
| | Betaine | C-35 | | | | | | |

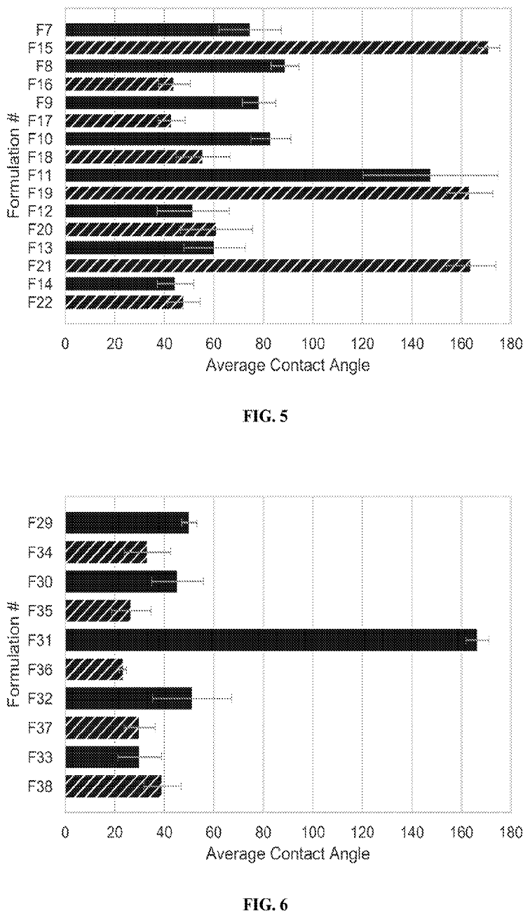

Several interesting observations resulted from these formulations as seen in FIG. 5 which plots the contact angle results of the formulations evaluated in Table 2. Formulations with a binary mixture of primary surfactant and cosurfactant are shaded in the bar plot while formulation containing only cosurfactants are non-shaded. A clear and strong synergy can be seen for formulations, F16, F17 and F18 which contained zwitterionic/amphoteric cosurfactants along with the primary surfactant. Specifically, the percentage reduction of contact angle as compared to formulations with no primary surfactant (Calfax 10L-45 in this case) was 50.5% (from 88.80 to 44.00), 45.2% (from 78.30 to 42.90), 33.0% (from 83.00 to 55.60) for formulations F16, F17, and F18, respectively. Note that the final wettability state due to primary surfactant alone (F72) was strongly oil-wet (θ=160.9±2.5), and final wettability state due to the individual cosurfactants alone (F78, F9, and F10) was neutral-wet. However, remarkably, the final wettability state for the formulations with a mixture of surfactants (F716, F17, and F18) was water-wet in nature. These results illustrate the non-obvious result of how the incorporation of suitable primary surfactants with other cosurfactants can result in a synergistic reduction of contact angle towards favorable water-wet conditions.

To further understand the improvement of synergistic surfactant blends in favorably altering the wettability of shale cores, the synergistic formulations were further evaluated with the oil-wet Wolf Camp shale samples. Analogous to cases of Eagle Ford shale samples, a similar protocol was adopted to cut and polish the shale disks and age them with reservoir crude oil. After the aging process, one of the disks was taken out of the crude oil and submerged in the formation brine (5 wt. % KCl) with no surfactant for 48 hours at 85° C. The disk was taken out and the contact angle of the crude oil was measured. It was equal to 177.4°±4.4° indicating the aging process was able to make the shale disks strongly oil-wet in nature. In the subsequent runs, surfactant formulations with individual surfactants with a constant salinity of 5 wt. % KCl was used to treat the oil-wet Wolf Camp shale disks. The treatment conditions (time=48 hours and temperature=85° C.) were kept constant. Table 3 lists the results of the different surfactant formulations (F24 to F33) comprising of individual surfactants. The total surfactant concentration was kept constant and equal to 0.5 wt. %.

TABLE 3
Wolf Camp Shale Samples

| | | | | Average | | | | |
|---|---|---|---|---|---|---|---|---|
| | | Trade | | Contact | Std. | Final | IOR | Flow-Back |
| # | Chemistry | Name | Type | Angle | Dev | Wettability | Application | Application |
| F23 | Formation Brine | — | — | 177.4 | 4.4 | OW | Fail | Pass |
| F24 | C10 (Linear) Sodium | Calfax | A | 160.1 | 13.3 | OW | Fail | Pass |
| | Diphenyl Oxide | 10L-45 | | | | | | |
| | Disulfonate | | | | | | | |
| F25 | C16 (Linear) Sodium | Calfax | A | 162.3 | 5.1 | OW | Fail | Pass |
| | Diphenyl Oxide | 16L-35 | | | | | | |
| | Disulfonate | | | | | | | |
| F26 | C12 (Branched) | Calfax | A | 165.6 | 1.3 | OW | Fail | Pass |
| | Sodium Diphenyl | DB-45 | | | | | | |
| | Oxide Disulfonate | | | | | | | |
| F27 | C6 (Linear) Diphenyl | Calfax | A | 138.0 | 8.3 | OW | Fail | Pass |
| | Oxide Disulfonic Acid | 6LA-70 | | | | | | |
| F28 | C12 (Branched) | Calfax | A | 159.0 | 9.1 | OW | Fail | Pass |
| | Diphenyl Oxide | DBA-70 | | | | | | |
| | Disulfonic Acid | | | | | | | |
| F29 | Cocamidopropyl | Macat | Z | 50.1 | 3.1 | WW | Pass | Fail |
| | hydroxysultaine | CAP HS | | | | | | |
| F30 | Lauramidopropyl | Caltaine | Z | 45.3 | 10.4 | WW | Pass | Fail |
| | Betaine | L-35 | | | | | | |
| F31 | Lauryl | Macat | Z | 166.5 | 4.6 | OW | Fail | Pass |
| | Hydroxysultaine | LHS | | | | | | |
| F32 | Ammonium Lauryl | Calfoam | A | 51.3 | 16.0 | WW | Pass | Fail |
| | Ether Sulfate | EA-603 | | | | | | |
| | (3 Mole EO) | | | | | | | |
| F33 | Cocamidopropyl | Caltaine | Z | 30.1 | 8.9 | WW | Pass | Fail |
| | Betaine | C-35 | | | | | | |

Similar to the Eagle Ford shale samples, the disulfonate-type surfactants (F24, F25, and F26) and disulfonic acid-type surfactants (F27, F28) could not alter the wettability state from oil-wet by themselves. In contrast, zwitterionic surfactants (F29, F30, and F33) and anionic surfactants (F732) were able to alter the wettability state of the Wolf Camp shale disks from strongly oil-wet to water-wet conditions.

Table 4 depicts the results of further testing of binary mixtures of primary surfactant comprising of 0.1 wt. % C10 (Linear) Sodium Diphenyl Oxide Disulfonate (Trade Name: Calfax 10L-45) and 0.4 wt. % of various cosurfactants with Wolf Camp shale samples. The results are further plotted in FIG. 6.

TABLE 4
Wolf Camp Shade Samples

| | | | | Average | | | | |
|---|---|---|---|---|---|---|---|---|
| | Cosurfactant | Trade | | Contact | Std. | Final | IOR | Flow-Back |
| # | Chemistry | Name | Type | Angle | Dev | Wettability | Application | Application |
| F34 | Cocamidopropyl | Macat | Z | 33.1 | 9.3 | WW | Pass | Fail |
| | hydroxysultaine | CAP HS | | | | | | |
| F35 | Lauramidopropyl | Caltaine | Z | 26.5 | 8.0 | WW | Pass | Fail |
| | Betaine | L-35 | | | | | | |
| F36 | Lauryl | Macat | Z | 23.4 | 1.5 | WW | Pass | Fail |
| | Hydroxysultaine | LHS | | | | | | |
| F37 | Ammonium | Calfoam | A | 30.0 | 6.3 | WW | Pass | Fail |
| | Lauryl Ether | EA-603 | | | | | | |
| | Sulfate | | | | | | | |
| | (3 Mole EO) | | | | | | | |
| F38 | Cocamidopropyl | Caltaine | A | 39.1 | 7.6 | WW | Pass | Fail |
| | Betaine | C-35 | | | | | | |

Interestingly, similar results analogous to Eagle Ford shale samples (Table 3 and FIG. 5) were observed for the results of Table 4 and FIG. 6 which indicate that the unexpected benefits of the synergistic formulations extend across different shale formations having different physical, mineralogical and geochemical characteristics. It can be seen that Formulation F34, F35, F36, and F37 resulted in reduction of contact angle by 33.8% (from 50.10 to 33.10), 41.5% (from 45.3° to 26.5°), 86.0% (166.5° to 23.4°), and 41.6% (51.3° to 30.0°).

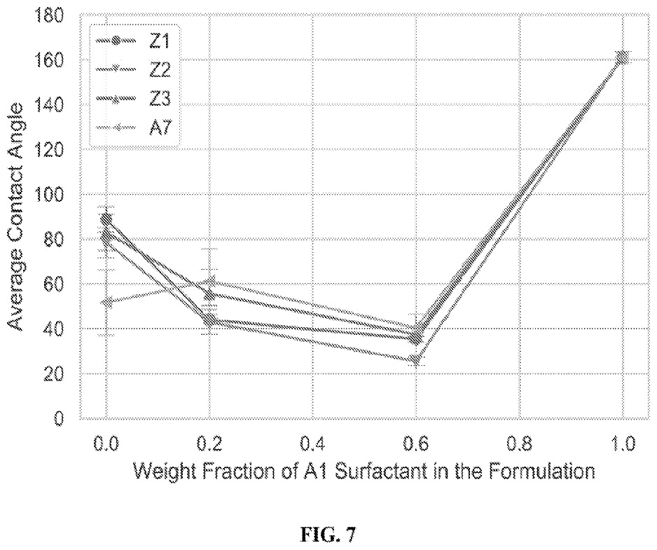

In the aforementioned examples, the ratio of primary surfactant to cosurfactant was 1:4 in the binary mixture. As can be appreciated, this ratio can be varied to achieve the desired wettability. To illustrate this, FIG. 7 plots the final wettability of treated initially oil-wet Eagle Ford shale rocks by formulations with four different cosurfactants in which the weight fraction of primary surfactant was varied from 0 to 1. In this experiment, the total concentration of surfactant and cosurfactant was kept constant at 0.5 wt %.

As depicted in FIG. 7, it can be seen that for all four cases, an optimal concentration of primary surfactant was seen which will yield the smallest contact angle (most water-wet system). By changing the weight fraction, control over the final wettability can be achieved which covers the whole wettability spectrum from water-wet to neutral-wet to oil-wet. Thus, depending on the application such as improved oil recovery (IOR) or flow-back process, an optimal ratio of primary surfactant to cosurfactant can be selected to yield a desired wettability which will maximize hydrocarbon recovery.

Based on the results depicted in FIG. 7, formulations F16′, F17′, and F18′ were further prepared. Formulations F16′, F17′, and F18′ correspond to a binary mixture of primary surfactant and cosurfactant in a 3:2 ratio (corresponding to data points of weight fraction=0.6 in FIG. 7). For each of formulations F16′, F17′, and F18′, the primary surfactant is 0.3 wt. % C10 (linear) sodium diphenyl oxide disulfonate (Trade Name: Calfax 10L-45). The cosurfactants in F16′, F17′, and F18′ are, respectively: 0.2 wt. % cocamidopropyl hydroxysultaine; 0.2 wt. % lauramidopropyl betaine; and 0.2 wt. % lauryl hydroxysultaine.

Bulk Emulsion Stability Tests

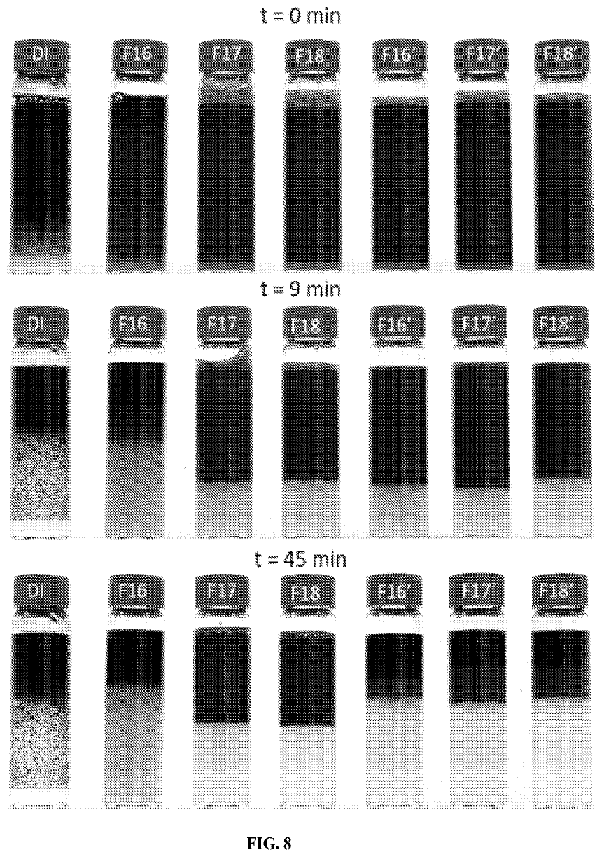

In the Bulk Emulsion Stability Tests, crude oil and various surfactant formulations were prepared in a 30:70 ratio in glass vials. The formulations were mixed vigorously under high shear using a rotor-stator homogenizer operating at 8,000 rpm for 45 seconds. FIG. 8 depicts digital images of the emulsion at different times for the case of DI water (reference case) and different surfactant formulations (F16, F17, F18, F16′, F17′, F18′). The initial height of emulsion at t=0 min was equal to the total height of the fluid. Normalized Emulsion Height (“NEH”) values were then generated by calculating the ratio of the height of emulsion at any time and the initial height.

The stability of the emulsions were plotted in FIG. 9 in terms of the NEH as a function of time. The formed emulsion in each case showed instant coalescence behavior. The half-life of the emulsion which is the time it takes for the emulsion to break till half its height can be calculated from the plot. In FIG. 9, the half life is represented as the horizontal dotted line corresponding to NEH=50. The half-lives were measured to be 2.4, 6.8, 11.8, 8.9, 11.7, 13.3, and 10.2 mins for DI, F16, F17, F18, F16′, F17′, F18′, respectively.

As can be appreciated, emulsion stability is a strong function of the type of surfactant, oil-water ratio, brine salinity, and mixing shear rate. For improved oil recovery applications in tight porous media such as shale, it is desirable to avoid the formation of strong in-situ emulsions which can reduce the reservoir productivity drastically. The emulsion stability can vary from ultra-stable (half-life order of years) to moderate stable (half-life order of hours) to weakly stable (half-life order of minutes) to unstable (half-life order of seconds). The half-life of the emulsions of the formulations in the present disclosure was only of the order of a few minutes indicating minimal in-situ emulsion formation potential.

Interfacial Tension

The Bulk Emulsion Stability Tests showed that the screened surfactant formulations did not yield stable microemulsions. Stable microemulsions are a qualitative indication that the interfacial tension (“IFT”) between crude oil and surfactant formulation do not have values in the ‘ultra-low range’ of IFT values. To confirm, IFT values were directly measured.

To quantify IFT values, pendant drop IFT analysis was performed using a goniometer. Table 5 summarizes the IFT results in mN/m for formulations F16, F17, F18, F16′, F17′, and F18′, as well as deionized water with no surfactant.

TABLE 5

| | Ratio of | |
|---|---|---|
| | primary | |
| | surfactant: | IFT, |
| Formulation | cosurfactant | mN/m |
| DI | — | 19.52 ± 0.13 |
| F16 | 1:4 | 0.28 ± 0.02 |
| F17 | 1:4 | 1.19 ± 0.09 |
| F18 | 1:4 | 1.17 ± 0.06 |
| F16' | 3:2 | 1.75 ± 0.08 |
| F17' | 3:2 | 2.42 ± 0.06 |
| F18' | 3:2 | 1.75 ± 0.08 |

As depicted in Table 5, the base case was deionized (DI) water with no surfactant which yielded an IFT value of 19.52±0.13 mN/m. This value was relatively lower than the typical oil-water IFT which indicates the presence of natural surface-active components in crude oil such as indigenous naphthenic acids. The IFT values for the various surfactant formulation varied from 0.1 to 1 mN/m as opposed to ultra-low IFT values (<0.001 mN/m) which confirmed the observations from the Bulk Emulsion Stability Test. Ultra-low IFTs, which are typically preferred in chemical EOR in conventional formations, may result in oil redeposition on the surface and water expelling out of matrix due to negligible capillary pressures. Accordingly, the screened formulations are expected to show minimal affinity to form in-situ microemulsions in the porous media and are ideal candidates for surfactant imbibition in shales which is desirable for IOR applications in tight formations.

Spontaneous Imbibition Test

The efficacy of the surfactant formulations in altering the wettability of the aged oil-wet cores and inducing surfactant solution imbibition to recover the crude oil was performed. Because shale samples have ultra-low porosity and permeability, the maximum initial oil saturation is relatively low for lab-scale experiments. Accordingly, Indiana limestone core plugs (length: 3 inches, diameter: 1 inch) were used as a proxy to better simulate a tight formation. These cores are also geochemically similar to calcite-rich Eagle Ford and Wolfcamp shales. To evaluate formulations in the Spontaneous Imbibition Test, the cores were placed in a coreholder under confining pressure of 1500 psi. The permeabilities of these cores were around 7.5 mD. These cores were vacuum-saturated with crude oil to obtain 100% initial oil saturation (Soᵢ) or 0% initial water saturation (Swᵢ). The core plugs were taken out of the coreholder and placed in a glass jar and were submerged in the crude oil. The jar was then placed in an oven at 85° C. for 1 month to render the cores oil-wet in nature. The aging process is a strong function of initial water saturation or connate water saturation, oil composition, aging time, and temperature. It is known in the literature that the degree of wettability alteration towards oil-wetness typically increases with a decrease in the initial water saturation (Swᵢ). Since the Swᵢ in the Indiana limestone core plugs is zero, the wettability state of the cores was “strongly oil-wet” or “SOW”. Due to the absence of any water film in the cores during aging, and 100% of the pores being filled with crude oil, the wettability-altering components in the crude oil are strongly adsorbed on the surface of the rock pores. For the cases with Swᵢ>0, the final wettability state of the cores after aging is mixed-wet.

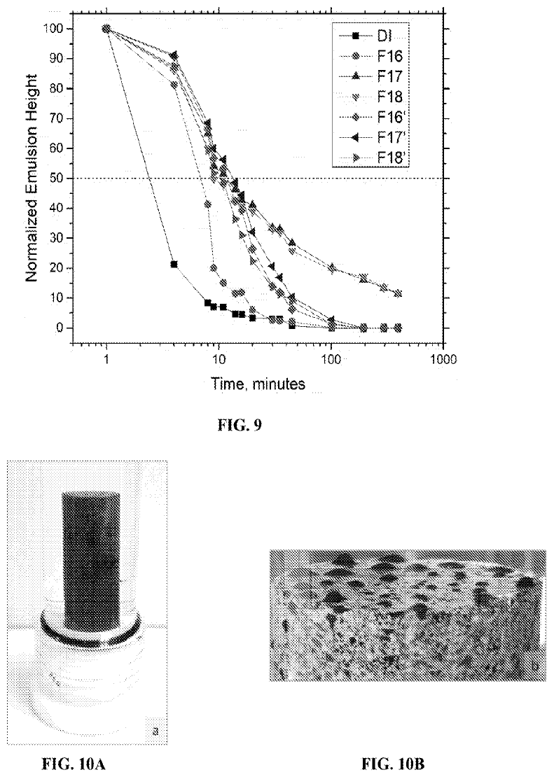

After the aging process, the saturated oil-wet core plugs were placed in a custom-designed Amott cell and were filled with various surfactant formulations and placed in the oven operating at 85° C. FIG. 10A depicts the initial state of the core submerged in the surfactant formulation in an Amott cell.

FIG. 11 compares the performance of six surfactant formulations: F16, F17, F18, F16′, F17′, F18′, and brine. FIG. 11 specifically plots the percentage of original-oil-in-place recovered as a function of time for these formulations. In just 1-hour, significant oil droplets were seen the surface of the core indicating quick surfactant solution imbibition in the cores. The emergence of the crude oil droplets on the surface of the cores is shown in FIG. 10B. The primary surfactant in these three cases was C10 (Linear) sodium diphenyl oxide disulfonate (Calfax 10L-45) while the cosurfactants were cocamidopropyl hydroxysultaine, lauramidopropyl betaine, and lauryl hydroxysultaine, respectively.

The final cumulative oil recovery for the reference case, brine (5 wt % KCl) with no surfactant was only 6.1% OOIP. The final cumulative oil recovery at the end of 380 hours for F16, F17, and F18 was 12.89% OOIP, 11.82% OOIP, and 23.12% OOIP, respectively indicating the potential of the formulation in recovering oil from oil-wet tight formations. These recoveries are significant given the fact that the initial wettability state was SOW.

Formulations F16′, F17′, and F18′, having a 3:2 ratio of 0.1 wt. % C10 (Linear) sodium diphenyl oxide disulfonate to cosurfactant, instead of a 1:4 ratio (as in F16, F17, and F18), demonstrated even greater cumulative oil recoveries. The cumulative oil recovery at the end of 1008 hours for F16′, F17′, and F18′ was 22.21% OOIP, 22.25% OOIP, and 30.80% OOIP, respectively. Formulations F16′, F17′, and F18′ outperformed F16, F17, and F18 in oil recovery and followed the same trend as the average contact angle as shown in FIG. 7. Formulation F18′ showed the best performance in improving the oil recovery with 404.5% increment as compared to the base case.

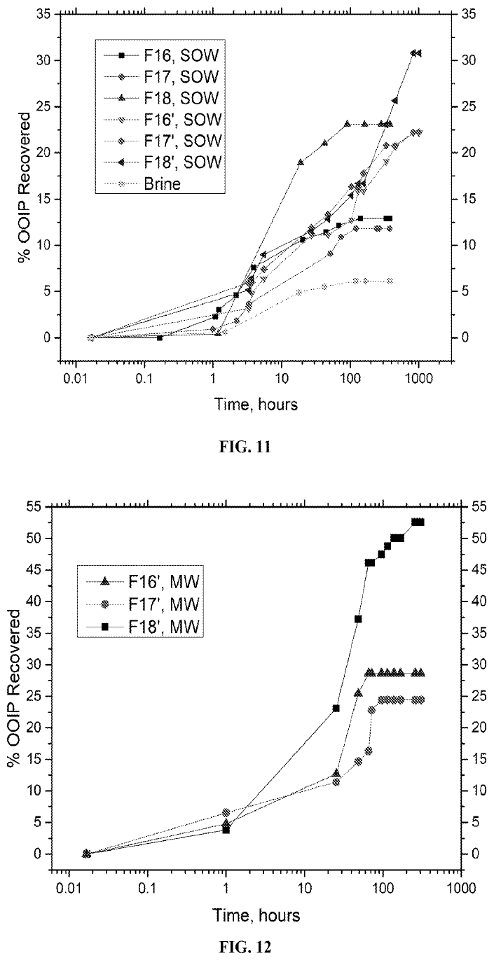

Based on these results, formulations F16′, F17′, and F18′ were further evaluated using mixed-wet (“MW”) Indiana limestone cores. FIG. 12 depicts a plot showing the percentage of original-oil-in-place (“OOIP”) recovered during spontaneous imbibition tests using mixed-wet (“MW”) cores for formulations F16′, F17′, and F18′.

The total oil recovery at the end of 306 hours for F16′, F17′, and F18′ was 28.63% OOIP, 24.43% OOIP, and 52.62% OOIP, respectively. As expected, the recoveries in these mixed-wet (MW) cases were higher than previous cases where the wettability was “strongly oil-wet”. These show the great potential of these synergistic surfactant blends in improving the oil recovering for tight formations in field applications.

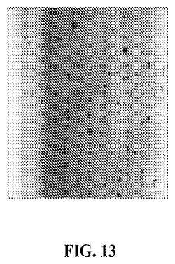

Formulation F18′ was further evaluated using oil-wet shale cores. A similar experimental procedure was adopted as before. Crude oil droplets were observed on the surface of the shale surface in just a few hours once they were placed in the surfactant formulation as depicted in FIG. 13. The total oil recoveries at the end of 7 days are listed in Table 6. This demonstrates that by utilizing the synergy between surfactants, a significant amount of oil can be recovered from ultra-tight shale rocks via the imbibition of surfactant solutions.

TABLE 6

| | | | % OOIP |
|---|---|---|---|
| Core Type | Diameter | Length | Recovered |
| Eagle Ford | 1 inch | 6 inches | 12.96% |
| Wolf Camp | 1 inch | 6 inches | 22.40% |

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. Certain embodiments disclosed herein can be combined with other embodiments as would be understood by one skilled in the art. The scope is, of course, not limited to the examples or embodiments set forth herein but can be employed in any number of applications and equivalent articles by those of ordinary skill in the art. Rather it is hereby intended the scope be defined by the claims appended hereto.

1-41. (canceled)

42. A surfactant concentrate composition for treating hydrocarbon-bearing subterranean formations, comprising:
a) one or more anionic disulfonated surfactants; and
b) one or more cosurfactants.

43. The surfactant concentrate composition of claim 42, wherein the one or more anionic disulfonated surfactants are represented by Formula I: 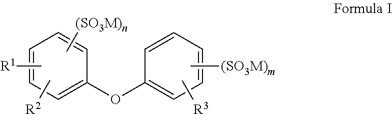
wherein:
R¹—represents a hydrogen, or a linear or branched C₆-C₃₀ alkyl;
R²—represents a hydrogen, or a linear or branched C₆-C₃₀ alkyl;
R³—represents a hydrogen, or a linear or branched C₆-C₃₀ alkyl;
M—represents an alkali metal, an ammonium represented by N(R⁴)₄, or an aminoalcohol, or SO₃M is SO₃H; wherein R⁴ independently represents a hydrogen, or a linear or branched C3-C6 alkyl;
m—represents an integer of 1 or 2; and
n—represents an integer of 0 or 1; and
wherein at least one and no more than two of R¹, R², and R³, represents a linear or branched C₆-C₃₀ alkyl.

44. The surfactant concentrate composition of claim 43, wherein the one or more anionic disulfonated surfactants are represented by Formula I, and wherein:
a) R¹ represents a linear or branched alkyl group with an average carbon chain length of about 6, 10, 12, or 16.
b) R² and R³ represent a hydrogen

45. The surfactant concentrate composition of claim 42, wherein the one or more anionic disulfonated surfactants comprise C10 (Linear) Sodium Diphenyl Oxide Disulfonate, C16 (Linear) Sodium Diphenyl Oxide Disulfonate, C6 (Linear) Diphenyl Oxide Disulfonic Acid, C12 (Branched) Sodium Diphenyl Oxide Disulfonate, C12 (Branched) Diphenyl Oxide Disulfonic Acid, or C12 (Branched) Diphenyl Oxide Disulfonic Acid.

46. The surfactant concentrate composition of claim 42, wherein the cosurfactant comprises an anionic surfactant represented by Formula II: 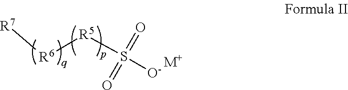
wherein:
R⁵ is a C₅-C₂₀ alkylene chain, a C₆H₄ phenylene group, or O;
R⁶ is alkylene oxide units represented by -(EO)ᵣ—(PO)ₛ—, where EO represents oxyethylene, PO represents oxypropylene, r represents an integer of 0 to 30; s represents an integer of 0 to 30;
R⁷ is a hydrogen or a linear or branched C₅-C₂₀ alkyl chain;
p represents an integer of 1 or 2;
q represents an integer of 0 or 1; and
M represents a hydrogen, or a cation comprising an alkali metal, alkaline earth metal, alkanolammonium, aminoalcohol ion, or an ammonium represented by N(R⁴)₄; wherein R⁴ independently represents a hydrogen, or a linear or branched C3-C6 alkyl;

47. The surfactant concentrate composition of claim 46 where the cosurfactant comprises an olefin sulfonate-type anionic surfactant represented by Formula II, wherein:
i. R⁵ represents an alkylene chain with average carbon chain length of about 12 or about 14 to 16;
ii. R⁷ represents a hydrogen;
iii. p represents an integer equal to 1; and
iv. q represents an integer equal to 0.

48. The surfactant concentrate composition of claim 46 where the cosurfactant comprises an alkyl benzene or alkyl aryl sulfonate-type anionic surfactant represented by Formula II, wherein:
i. R⁵ represents a C₆H₄ phenylene group;
ii. R⁷ represents a linear or branched C₅-C₂₀ alkyl chain;
iii. p represents an integer equal to 1; and
iv. q represents an integer equal to 0.

49. The surfactant concentrate composition of claim 46 where the cosurfactant comprises an alkyl sulfate-type anionic surfactant represented by Formula II, wherein:
i. R⁵ represents an O (oxygen);
ii. R⁷ represents a linear or branched C₅-C₂₀ alkyl chain;
iii. p represents an integer equal to 1; and
iv. q represents an integer equal to 0.

50. The surfactant concentrate composition of claim 46 where the cosurfactant comprises an alkyl ether sulfate-type anionic surfactant represented by Formula II, wherein:
i. R⁵ represents an O (oxygen);
ii. R⁶ is alkylene oxide units represented by -(EO)ᵣ—(PO)ₛ—, where EO represents oxyethylene, PO represents oxypropylene, r represents an integer of 1 to 30; s represents an integer equal to 0;
iii. R⁷ represents a linear or branched C₅-C₂₀ alkyl chain;
iv. p represents an integer equal to 1; and
v. q represents an integer equal to 1.

51. The surfactant concentrate composition of claim 42, wherein the cosurfactant comprises a zwitterionic/amphoteric surfactant represented by Formula III or Formula IV: 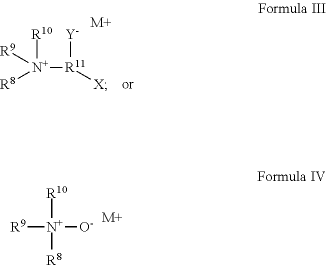
wherein:
R⁸ is a linear or branched C₅-C₂₀ alkyl;
R⁹ and R¹⁰ are each a C₁-C₃ alkyl;
R¹¹ is an alkyl or alkylene group containing 1 to 3 carbon atoms;
X is a hydrogen or hydroxyl group;
Y is a carboxyl or sulfonate group; and
M represents a hydrogen, or a cation comprising an alkali metal, alkaline earth metal, alkanolammonium, aminoalcohol ion, or an ammonium represented by N(R⁴)₄; wherein R⁴ independently represents a hydrogen, or a linear or branched C3-C6 alkyl.

52. The surfactant concentrate composition of claim 51 where the cosurfactant comprises a hydroxy-sultaine-type zwitterionic and/or amphoteric surfactant represented by Formula III, wherein:
i. R⁸ is a group represented by R¹²CONH(CH₂)₃ where R¹² is a saturated or unsaturated alkyl group with at least 6 carbon atoms;
ii. R⁹ and R¹⁰ are each a methyl (—CH₃);
iii. R¹¹ is an alkyl or alkylene group containing 3 carbon atoms;
iv. X is a hydroxyl group;
v. Y is a sulfonate (—SO3⁻) group.

53. The surfactant concentrate composition of claim 51 where the cosurfactant comprises a betaine-type zwitterionic and/or amphoteric surfactant represented by Formula III, wherein:
i. R⁸ is a group represented by R¹²CONH(CH₂)₃ where R¹² is a saturated or unsaturated alkyl group with at least 6 carbon atoms;
ii. R⁹ and R¹⁰ are each a methyl (—CH₃);
iii. R¹¹ is an alkylene group (—CH);
iv. X is a hydrogen;
v. Y is a carboxyl (—COO⁻) group.

54. The surfactant concentrate composition of claim 51 where the cosurfactant comprises an amine oxides-type zwitterionic and/or amphoteric surfactant represented by Formula IV, wherein:
i. R⁸ is a linear or branched, saturated or unsaturated alkyl group with at least 6 carbon atoms; and
ii. R⁹ and R¹⁰ are each a methyl (—CH₃)

55. The surfactant concentrate composition of claim 42, wherein the cosurfactant comprises a non-ionic surfactant represented by Formula V: 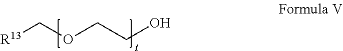
wherein:
R¹³ is a linear or branched C₅-C₂₀ alkyl; and
t represents an integer from 1 to 20.

56. The surfactant concentrate composition of claim 42, wherein the cosurfactant comprises a cationic surfactant represented by Formula VI: 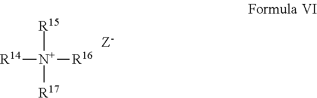
wherein:
R¹⁷ and R¹⁴ are each a short chain linear or branched C₁-C₃ alkyl;
R¹⁵ and R¹⁶ are independently selected from linear or branched C₁-C₂₄ alkyl, aromatic, benzyl, alkylamido, aryl or alkylaryl groups; and
Z is a salt-forming anion comprising halide anions, acetate, and citrate.

57. The surfactant concentrate composition of claim 56, wherein the cosurfactant comprises a cationic surfactant represented by Formula VI wherein:
i. R¹⁷ and R¹⁴ are each a methyl group (—CH₃);
ii. R¹⁵ is a benzyl group (C₆H₅CH₂—); and
iii. R¹⁶ is a linear or branched C₁-C₂₄ alkyl.

58. The surfactant concentrate composition of claim 42 comprises:
about 5% to about 95%, by weight, water,
about 5% to about 95%, by weight, of the one or more anionic disulfonated surfactants,
about 0.01% to about 95%, by weight, of the cosurfactants.

59. The surfactant concentrate composition of claim 42, wherein the ratio of the one or more anionic disulfonated surfactants to the one or more cosurfactants is a ratio of about 1:2 to a ratio of about 3:2.

60. The surfactant concentrate composition of claim 42, further comprising about 0% to about 30%, by weight, of one or more additives selected from the group consisting of acids, biocides, clay stabilizers, breakers, corrosion inhibitors, crosslinkers, friction reducers, polymers, oxygen scavengers, pH adjusting agents, scale inhibitors, non-emulsifier, and mixture thereof.

61. The surfactant concentrate composition of claim 42 exhibits an emulsion stability half-life of about 6 minutes to about 12 minute and an interfacial tension of about 0.25 mN/m to about 2.5 mN/m.
